(19) United States
(12) Patent Application Publication
(10) Pub. No.: US 2009/0011937 A1
(43) Pub. Date: Jan. 8, 2009

(54) Use of Fungicides for Increasing the Quality and Optionally the Quantity of Oil-Plant Products

(76) Inventors: Herve R. Vantieghem, Stutensee (DE); Matthias Bauer, Nurnberg (DE); Andreas Haase, Mannheim (DE)

Correspondence Address: BIRCH STEWART KOLASCH & BIRCH, PO BOX 747, FALLS CHURCH, VA, 22040-0747, US

(21) Appl. No.: 12/223,289

(22) PCT Filed: Feb. 1, 2007
(86) PCT No.: PCT/EP2007/050998

§ 371 Date: Jul. 28, 2008

(30) Foreign Application Priority Data
Feb. 3, 2006 (EP) 06002296.9

(51) Int. Cl. A01N 43/54; A01N 43/84; A01P 21/00

(52) U.S. Cl. 504/136; 504/224

(57) ABSTRACT

The present invention relates to the use of certain fungicides for increasing the quality and, if appropriate, the quantity of oil crop products. It also relates to the use of these fungicides for reducing the brittleness of the seed coats of seed oil crops. Furthermore, it relates to oil plant products which can be obtained from oil crops which have been treated with these fungicides, for example oils or seeds from oil crops which have been treated in this manner. Furthermore, it also relates to renewable fuels which comprise the oil according to the invention and/or reaction products thereof. Finally, it relates to a method of improving the combustion in engines and furnace installations, in which these are operated at least to some extent with a suitable oil crop product according to the invention.

The present invention relates to the use of certain fungicides for increasing the quality and, if appropriate, the quantity of oil crop products. It also relates to the use of these fungicides for reducing the brittleness of the seed coats of seed oil crops. Furthermore, it relates to oil crop products which can be obtained from oil crops which have been treated with these fungicides, for example oils or seeds from oil crops which have been treated in this manner. Furthermore, it also relates to renewable fuels which comprise the oil according to the invention and/or reaction products thereof. Finally, it relates to a method of improving the combustion in engines and furnace installations, in which these are operated at least to some extent with a suitable oil crop product according to the invention.

As a result of the predictable exhaustion of fossil fuels, the energy sector focuses increasingly on renewable fuels such as, for example, vegetable oils, biodiesel and bioethanol. Biodiesel refers to the lower-alkyl esters, in particular the methyl esters, of fatty acids. These are obtainable by transesterifying with an alcohol (such as methanol), vegetable oils such as rapeseed oil, but also used fats and used oils, and animal fats which occur naturally in the form of triglycerides. Vegetable oils are, as a rule, obtained by pressing the oil-comprising plant parts of oil crops, for example of oil-comprising fruits or seeds. However, cold-pressing and, in particular, warm-pressing gives an oil which has a relatively high content in phosphorus compounds and mineral compounds, such as alkali metal and in particular alkaline earth metal compounds, mainly calcium compounds and magnesium compounds. These compounds, which can be present not only in the oil but also in reaction products thereof, can have an adverse effect on combustion in engines and furnace installations. Moreover, they have a negative effect on the longevity of the material of engines. Negative effects on the exhaust systems can also not be excluded. Thus, the abovementioned compounds result in not inconsiderable ash formation during the combustion operation which puts a strain on, for example, particle filters of diesel vehicles. Nor can the ash be removed by regenerating the particle filter, but it is retained in the filter, which leads to an increased exhaust gas counterpressure. An increased exhaust gas counterpressure leads, in turn, to malfunction in the diesel engine. In addition, phosphorus compounds act as catalyst poisons and reduce for example the service life of oxidation-type catalytic converters in diesel vehicles and of SCR-type catalytic converters in utility vehicles such as trucks and tractors. Similar problems may also occur in heating installations. To avoid these problems, and also to be able to meet the DIN standard for rapeseed oil as power fuel, which can be expected in the very near future (E DIN 51605), biodiesel or the vegetable oils on which it is based are currently subjected to complicated processing procedures.

Even when meeting the abovementioned DIN standard for rapeseed oil, it cannot be ensured that the transport, the storage or the combustion of vegetable oils or their reaction products is problem-free. Thus, certain phosphorus compounds, in particular phospholipids, even when present in the vegetable oil in an amount below the phosphorus limit specified in DIN 51605, lead to the clogging of motor-fuel filters in engines, tanks and industrial production plants. It is therefore desirable to reduce the phosphorus content, and also the content of other undesirable companion substances in the oil even more than specified by DIN 51605.

When using vegetable oils in the food sector and in the cosmetics sector, or when using oil crop products, for example from seeds and presscakes, in the feed sector, too, phosphorus compounds, in particular phosphates, may be a problem e.g. for health reasons.

The abovementioned phosphorus and mineral compounds originate firstly from the oil-yielding plant parts, such as pulp from fruits or seeds, themselves. When obtaining the vegetable oil from the seeds of seed oil crops, the phosphorus compounds and/or the alkali metal and alkaline earth metal compounds originate at least in part also from the seed coat, from which they are extracted especially when applying high pressures during the pressing procedure. When applying high pressures, which are required for a sufficiently high oil yield, the seed coat, which, as a rule, is very brittle, bursts. As the result of this, not only microscopic fragments, or fragments which are visible with the naked eye, end up in the oil and are then visible as suspended matter, but also the surface of the seed coat is enlarged, enhancing the extraction of undesired secondary substances.

Since, in principle, all plant parts such as presscake and seeds may be employed as renewable motor fuels, it is also important for these oil-plant products to be as low as possible in phosphorus and minerals.

Another problem of oil crop products and in particular of vegetable oils and, if appropriate, of their reaction products is their acid content, which can lead to corrosion in engines and furnace installations, for example in boilers.

It is furthermore desirable to provide vegetable oils and reaction products thereof with the lowest possible iodine number. The iodine number is a measure for the number of C—C double bonds in the fatty acid molecules on which the oil or its reaction products is/are based, i.e. for the unsaturated character of the oil. Oils with a high iodine number are more sensitive to oxidation, and therefore resinify more quickly than oils with a higher degree of saturation, so that their storage stability is lower. In total, it is desirable to provide vegetable oils, or reaction products thereof, with as high as possible a resistance to oxidation, since sufficient resistance to oxidation, which is an important aspect of storage stability, is mandatory for successful commercialization. The resistance to oxidation is determined not only by the oil's degree of saturation, but also by the presence of antioxidants, such as vitamin A or vitamin E.

A further problem of vegetable oils, in particular regarding the aspect of their use in the motor fuel sector, is that their viscosity is relatively high in comparison with mineral motor fuels. Owing to the poorer flowing, pumping and atomizing behavior at the fuel injectors (droplet spectrum and geometry of the injection string), high viscosities lead, inter alia, to cold-start problems. It is therefore desirable to be able to provide-vegetable oils with reduced viscosity, in particular with reduced kinematic viscosity.

It is also desirable to further improve the properties of oil-plant products, in particular of vegetable oils and their reaction products, with regard to their use in providing energy, for example a higher flashpoint, a higher calorific value, a higher cetane number, a lower coke residue, a reduced sulfur content, a reduced nitrogen content, a reduced chlorine content and a lower content in certain (semi)metal compounds such as zinc compounds, tin compounds, boron compounds and silicon compounds, of oil-plant products, especially vegetable oil or reaction products.

The flashpoint specifies the measured temperature at which, in a closed vessel, enough vapors emerge to form a vapor/air mixture which is ignitable by an externally supplied ignition force. The flashpoint is used for classifying fluids in classes of hazardous substances. Naturally, it is desirable to provide vegetable oils and reaction products thereof whose flashpoint is as high as possible.

The calorific value is a measure for the amount of energy which is released per volume or per mass upon complete combustion of a substance. The gross calorific value also comprises the energy which is released upon condensation of the steam generated during the combustion, while the net calorific value is corrected by this factor. Naturally, oil product products with the highest possible net calorific value are desirable.

The cetane number is a measure for the ignition quality of a diesel fuel and, naturally, motor fuels with good ignition qualities are particularly desirable.

The coke residue consists of organic and inorganic material which is generated upon incomplete combustion of motor fuel, and is a measure for the susceptibility to coking of a motor fuel at the fuel injectors and for the formation of residue in the combustion chamber. The coking of fuel injectors leads to poorer distribution of the injected motor fuel, and therefore to reduced engine performance. Coking in engines is currently suppressed mainly by the addition of specific detergents and dispersants. Naturally, motor fuels with a lesser tendency to coke are desirable.

The reduction of the contents of sulfur, nitrogen, chlorine and the abovementioned (semi)metals is intended mainly to reduce the output of substances which are a health and environmental hazard, such as sulfuric acid and other sulfur compounds and nitrous gases, to reduce the corrosive effect of oil-plant products, mainly of vegetable oils and reaction products thereof, on metal components which come into contact with the former, and to reduce ash formation, for example by the abovementioned (semi)metal compounds.

It was the object of the present invention to increase altogether the quality and, if appropriate, also the quantity of oil crop products, for example of vegetable oils and their reaction products, in particular with a view to a later use in the fuel sector, but also in the food and feed sector, without simultaneously having to resort to complicated preparation and purification steps.

Surprisingly, it has been found that oil crop products in a higher quality are obtained when the oil crops or their seed are treated with specific fungicides. In particular in the case of seed oil crops, it has been found that the treatment of these plants, or their seed, with the fungicides results in a reduced brittleness of the seed coats.

Accordingly, the object was achieved by the use of fungicides which are selected among aryl- and heterocyclylanilides, carbamates, dicarboximides, azoles, strobilurins and morpholines for increasing the quality and, if appropriate, the quantity of oil crop products.

In the context of the present invention, “increase of the quality” means that at least one oil-plant product of an oil crop has improved properties, in particular with a view to its use for providing energy, mainly in the combustion fuel or motor fuel sector. “Increase of the quality” therefore means that at least one oil-plant product must meet at least one of the following criteria:
(i) reduction of the phosphorus content of at least one oil-plant product;
(ii) reduction of the alkali metal and/or alkaline-earth metal content of at least one oil-plant product;
(iii) increase of the resistance to oxidation of at least one oil-plant product;
(iv) reduction of the overall contamination of at least one oil-plant product;
(v) reduction of the iodine number of at least one oil-plant product;
(vi) reduction of the acid number of at least one oil-plant product;
(vii) reduction of the kinematic viscosity of at least one oil-plant product;
(viii) reduction of the sulfur content of at least one oil-plant product;
(ix) increase of the flashpoint of at least one oil-plant product;
(x) increase of the net calorific value of at least one oil-plant product;
(xi) reduction of the coke residue of at least one oil-plant product;
(xii) increase of the cetane number of at least one oil-plant product;
(xiii) reduction of the nitrogen content of at least one oil-plant product;
(xiv) reduction of the chlorine content of at least one oil-plant product; and
(xv) reduction of the tin, zinc, silicon and/or boron content of at least one oil-plant product.

The increased quality and, if appropriate, increased quantity of the at least one oil-plant product relates to improvement in comparison with the quality and, if appropriate, the quantity of the same oil-plant product which is obtained in the same manner (regarding harvest, processing and the like) from the same oil crop (with regard to species and variety) under identical growth conditions of the plant, but without the treatment of the plant or its seed with the specified fungicides.

Another subject matter of the invention is the use of the abovementioned fungicides for reducing the brittleness of the seed coats of seed oil crops.

Oil crops are plants whose plant parts, in particular whose fruits and/or seeds, yield oil.

They can be divided into two main groups:
fruit pulp oil crops, where the oil is obtained from the fatty fruit pulp. These include, for example, olive trees and oil palms.
Seed oil crops, where the oil is obtained from the seeds. These include, for example, oilseed rape, turnip rape, mustard, oil radish, false flax, garden rocket, crambe, sunflower, safflower, thistle, calendula, soybean, lupine, flax, hemp, oil pumpkin, poppy, maize and nuts, in particular Arachis species (peanuts).

The two species mentioned above for the fruit pulp oil crops (olive tree and oil palm) can, however, also be included in the seed oil crops, since the seed (stone) of both is likewise used for obtaining oil.

For the purposes of the present invention, the terms “fruit” and “seed”, on which the definition of the terms “fruit pulp oil crops” and “seed oil crops” is based, are not used in the strict morphological sense, i.e. no differentiation is made on the basis of the flower parts from which the seed or the fruit develops. Rather, the term “seed” is understood as meaning, for the purposes of the present invention, the part of the plant which can be used as such, i.e. without further processing, as seed. The fruit, in contrast, is the totality of the organs which develop from a flower and which enclose the seeds until they are mature. A fruit comprises one or more seeds which are surrounded by the pericarp. For the purposes of the present invention, a fruit additionally comprises fruit pulp, which can readily be separated from the seed in the morphological sense. Moreover, in the case of a fruit for the purposes of the invention, the pericarp is not inseparably fused with the seed or the seed coat. Seed oil crops for the purposes of the invention thus comprise not only oil crops where the oil is obtained from seeds in the morphological sense, but also oil crops in which the oil is obtained from the kind of fruit where the pericarp is inseparably fused with the seed, as is the case for example in sunflowers, nuts or maize. Accordingly, for the purposes of the present invention, the term “seed coat” is not limited to the coat of seeds in the morphological sense, but also comprises the pericarps of fruits where the pericarp is inseparably fused with the seed and which thus come under the term “seeds” as used in accordance with the invention.

For the purposes of the present invention, oil crop products are understood as meaning all oil-comprising plant parts of oil crops, their processed products and reaction products, and the reaction products of the processed products. They are suitable as a source of energy, for example in the form of fuels, including motor fuels, as lubricants, but also for use in the food and feed sector, or else in the cosmetics sector. The oil crop products include mainly the oil-comprising fruits and seeds of oil crops, the oil obtained therefrom (which can be employed in the food sector, for example as edible oil or for the production of margarine, in the cosmetics sector, for example as carrier, as lubricant or as fuel, including motor fuel), the presscake obtained during the pressing process upon oil extraction (which can be employed in the feed sector as animal feed or as fuel) and the reaction products of the oil, for example its transesterification products with C₁-C₄-alcohols, preferably with methanol (which can be employed as biodiesel). Transesterification products of the oil with C₁-C₄-alcohols are understood as meaning the C₁-C₄-alcohol esters of the fatty acids which are present in the oil predominantly in the form of glycerides (mainly as triglycerides).

The oil crop products are preferably selected among vegetable oils and their reaction products, for example the transesterification products with C₁-C₄-alcohols, preferably with methanol.

For the purposes of the present invention, oils are understood as meaning vegetable oils, unless otherwise specified.

Furthermore, the invention relates to a method of increasing the quality and, if appropriate, the quantity of oil crop products, in which an oil crop or plant parts thereof during the vegetation phase of the plant (i.e. in the period from emergence to harvest) or its seed are treated with at least one of the abovementioned fungicides, and the oil crop products are obtained. The increase of the quality and, if appropriate, the quantity of oil-plant products is defined as hereinabove. The invention furthermore also relates to a method for reducing the brittleness of the seed coats of seed oil crops, in which a seed oil crop or plant parts thereof during the vegetation phase of the plant (i.e. in the period from emergence to harvest) or its seed are treated with at least one of the abovementioned fungicides. Moreover, the present invention relates to an oil crop product which is obtainable by the method according to the invention. The invention furthermore relates to a renewable fuel which comprises an oil obtainable in accordance with the invention and/or at least one C₁-C₄-alkyl ester thereof. Finally, the invention relates to a method of improving the combustion in engines and furnace installations, where these are operated at least to some extent with a suitable oil crop product according to the invention.

For the purposes of the present invention, the generic terms used have the following meanings:

Halogen represents fluorine, chlorine, bromine or iodine, in particular fluorine, chlorine or bromine.

The term “partially or fully halogenated” means that one or more, for example 1, 2, 3 or 4 or all hydrogen atoms of a particular radical are replaced by halogen atoms, in particular by fluorine or chlorine.

The term “Cₘ-Cₙ-alkyl” (also in Cₘ-Cₙ-haloalkyl, Cₘ-Cₙ-alkylthio, Cₘ-Cₙ-haloalkylthio, Cₘ-Cₙ-alkylsulfinyl and Cₘ-Cₙ-alkylsulfonyl) is a linear or branched saturated hydrocarbon radical having m to n, for example 1 to 8, carbon atoms. Thus, C₁-C₄-alkyl is, for example, methyl, ethyl, propyl, isopropyl, n-butyl, sec-butyl, isobutyl or tert-butyl.

C₁-C₈-Alkyl is, additionally, for example pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, heptyl, octyl, 2-ethylhexyl, and their constitutional isomers.

Cₘ-Cₙ-Haloalkyl is a linear or branched alkyl radical having m to n carbon atoms in which one or more hydrogen atoms are replaced by halogen atoms, in particular fluorine or chlorine. Thus, C₁-C₈-haloalkyl is a linear or branched C₁-C₈-alkyl radical in which one or more hydrogen atoms are replaced by halogen atoms, in particular fluorine or chlorine. C₁-C₈-Haloalkyl is, in particular, C₁-C₂-haloalkyl. C₁-C₂-Haloalkyl is, for example, chloromethyl, dichloromethyl, trichloromethyl, bromomethyl, fluoromethyl, difluoromethyl, trifluoromethyl, chlorofluoromethyl, dichlorofluoromethyl, chlorodifluoromethyl, 1-chloroethyl, 2-chloroethyl, 1-fluoroethyl, 2-fluoroethyl, 2,2-difluoroethyl, 2,2,2-trifluoroethyl, pentafluoroethyl and the like.

Cₘ-Cₙ-Alkoxy is a linear or branched alkyl radical having m to n carbon atoms which is bonded via an oxygen atom. Accordingly, C₁-C₄-alkoxy is a C₁-C₄-alkyl radical which is bonded via an oxygen atom. Examples are methoxy, ethoxy, propoxy, isopropoxy, butoxy, sec-butoxy, isobutoxy and tert-butoxy. Examples of C₁-C₈-alkoxy are, additionally, pentyloxy, hexyloxy, octyloxy and their constitutional isomers.

C₁-C₈-Haloalkoxy is a linear or branched C₁-C₈-alkyl radical which is bonded via an oxygen atom and in which one or more hydrogen atoms are replaced by a halogen atom, in particular by fluorine or chlorine. Examples are chloromethoxy, dichloromethoxy, trichloromethoxy, fluoromethoxy, difluoromethoxy, trifluoromethoxy, bromomethoxy, chlorofluoromethoxy, dichlorofluoromethoxy, chlorodifluoromethoxy, 1-chloroethoxy, 1-bromoethoxy, 1-fluoroethoxy, 2-chloroethoxy, 2-bromoethoxy, -2-fluoroethoxy, 2,2-difluoroethoxy, 2-chloro-2-fluoroethoxy, 2,2-dichloroethoxy, 2,2,2-trichloroethoxy, 2,2,2-trifluoroethoxy, pentafluoroethoxy, pentachloroethoxy and the like.

C₁-C₈-Alkylthio, C₁-C₈-alkylsulfinyl and C₁-C₈-alkylsulfonyl are a linear or branched C₁-C₈-alkyl radical which is bonded via a sulfur atom (alkylthio), an S(O) group (alkylsulfinyl) or an S(O)₂ group (alkylsulfonyl). Examples of C₁-C₈-alkylthio comprise methylthio, ethylthio, propylthio, isopropylthio, n-butylthio and the like. Examples of C₁-C₈-alkylsulfinyl comprise methylsulfinyl, ethylsulfinyl, propylsulfinyl, isopropylsulfinyl, n-butylsulfinyl and the like. Examples of C₁-C₈-alkylsulfonyl comprise methylsulfonyl, ethylsulfonyl, propylsulfonyl, isopropylsulfonyl, n-butylsulfonyl and the like.

C₁-C₄-Alkylthio is a linear or branched C₁-C₄-alkyl radical which is bonded via a sulfur atom. Examples comprise methylthio, ethylthio, propylthio, isopropylthio, n-butylthio and their constitutional isomers.

C₁-C₈-Haloalkylthio is a linear or branched C₁-C₈-alkyl radical which is bonded via a sulfur atom and in which one or more hydrogen atoms are replaced by a halogen atom, in particular by fluorine or chlorine. Examples are chloromethylthio, dichloromethylthio, trichloromethylthio, fluoromethylthio, difluoromethylthio, trifluoromethylthio, bromomethylthio, chlorofluoromethylthio, dichlorofluoromethylthio, chlorodifluoromethylthio, 1-chloroethylthio, 1-bromoethylthio, 1-fluoroethylthio, 2-chloroethylthio, 2-bromoethylthio, 2-fluoroethylthio, 2,2-difluoroethylthio, 2-chloro-2-fluoroethylthio, 2,2-dichloroethylthio, 2,2,2-trichloroethylthio, 2,2,2-trifluoroethylthio, pentafluoroethylthio, pentachloroethylthio and the like.

Cₘ-Cₙ-Alkoxy-Cₘ-Cₙ-alkyl is a Cₘ-Cₙ-alkyl group in which one hydrogen atom is replaced by a Cₘ-Cₙ-alkoxy group. Accordingly, C₁-C₈-alkoxy-C₁-C₈-alkyl is a C₁-C₈-alkyl group in which one hydrogen atom is replaced by a C₁-C₈-alkoxy group. Examples are methoxymethyl, ethoxymethyl, propoxymethyl, methoxyethyl, ethoxyethyl, propoxyethyl, methoxypropyl, ethoxypropyl, propoxypropyl and the like.

Cₘ-Cₙ-Alkylthio-Cₘ-Cₙ-alkyl is a Cₘ-Cₙ-alkyl group in which one hydrogen atom is replaced by a Cₘ-Cₙ-alkylthio group. Accordingly, C₁-C₈-alkylthio-C₁-C₈-alkyl is a C₁-C₈-alkyl group in which one hydrogen atom is replaced by a C₁-C₈-alkylthio group. Examples are methylthiomethyl, ethylthiomethyl, propylthiomethyl, methylthioethyl, ethylthioethyl, propylthioethyl, methylthiopropyl, ethylthiopropyl, propylthiopropyl and the like.

Cₘ-Cₙ-Haloalkylthio-Cₘ-Cₙ-alkyl is a Cₘ-Cₙ-alkyl group in which one hydrogen atom is replaced by a Cₘ-Cₙ-haloalkylthio group. Accordingly, C₁-C₈-haloalkylthio-C₁-C₈-alkyl is a C₁-C₈-alkyl group in which one hydrogen atom is replaced by a C₁-C₈-haloalkylthio group. Examples are chloromethylthiomethyl, dichloromethylthiomethyl, trichloromethylthiomethyl, chloroethylthiomethyl, dichloroethylthiomethyl, trichloroethylthiomethyl, tetrachloroethylthiomethyl, pentachloroethylthiomethyl and the like.

Carboxyl is a group —COOH.

C₁-C₈-Alkylcarbonyl is a group —CO—R in which R is C₁-C₈-alkyl.

C₁-C₈-Alkyloxycarbonyl (also referred to as C₁-C₈-alkoxycarbonyl) is a group —C(O)O—R in which R is C₁-C₈-alkyl.

C₁-C₈-Alkylcarbonyloxy is a group —OC(O)—R in which R is C₁-C₈-alkyl.

C₁-C₈-Alkylaminocarbonyl is a group —CO—NH—R in which R is C₁-C₈-alkyl.

Di(C₁-C₈-alkyl)aminocarbonyl is a group —CO—N(RR′) in which R and R′, independently of one another, are C₁-C₈-alkyl.

C₂-C₈-Alkenyl is a linear or branched hydrocarbon radical having 2 to 8 carbon atoms and one double bond in any position. Examples are ethenyl, 1-propenyl, 2-propenyl (allyl), 1-methylethenyl, 1-, 2- and 3-butenyl, 1-methyl-1-propenyl, 2-methyl-1-propenyl, 1-, 2-, 3- and 4-pentenyl, 1-, 2-, 3-, 4- and 5-hexenyl, 1-, 2-, 3-, 4-, 5- and 6-heptenyl, 1-, 2-, 3-, 4-, 5-, 6- and 7-octenyl and their constitutional isomers.

C₂-C₈-Alkenyloxy is a C₂-C₈-alkenyl radical which is bonded via an oxygen atom: Examples are ethenyloxy, propenyloxy and the like.

C₂-C₈-Alkenylthio is a C₂-C₈-alkenyl radical which is bonded via a sulfur atom. Examples are ethenylthio, propenylthio and the like.

C₂-C₈-Alkenylamino is a group —NH—R in which R is C₂-C₈-alkenyl.

N—C₂-C₈-Alkenyl-N—C₁-C₈-alkylamino is a group —N(RR′) in which R is C₂-C₈-alkenyl and R′ is C₁-C₈-alkyl.

C₂-C₈-Alkynyl is a linear or branched hydrocarbon radical having 2 to 8 carbon atoms and at least one triple bond. Examples are ethynyl, propynyl, 1- and 2-butynyl and the like.

C₂-C₈-Alkynyloxy is a C₂-C₈-alkynyl radical which is bonded via an oxygen atom. Examples are propynyloxy, butynyloxy and the like.

C₂-C₈-Alkynylthio is a C₂-C₈-alkynyl radical which is bonded via a sulfur atom. Examples are ethynylthio, propynylthio and the like.

C₂-C₈-Alkynylamino is a group —NH—R in which R is C₂-C₈-alkynyl.

N—C₂-C₈-Alkynyl-N—C₁-C₈-alkylamino is a group —N(RR′) in which R is C₂-C₈-alkynyl and R′ is C₁-C₈-alkyl.

C₃-C₈-Cycloalkyl is a monocyclic 3- to 8-membered saturated cycloaliphatic radical. Examples are cyclopropyl, cyclobutyl, cyclopentyl, cyclohexyl, cycloheptyl and cyclooctyl.

C₃-C₈-Cycloalkyloxy (or C₃-C₈-cycloalkoxy) is a C₃-C₈-cycloalkyl radical which is bonded via oxygen. Examples are cyclopropyloxy, cyclobutyloxy, cyclopentyloxy, cyclohexyloxy, cycloheptyloxy and cyclooctyloxy.

C₃-C₈-Cycloalkylthio is a C₃-C₈-cycloalkyl radical which is bonded via a sulfur atom. Examples are cyclopropylthio, cyclobutylthio, cyclopentylthio, cyclohexylthio, cycloheptylthio and cyclooctylthio.

C₃-C₈-Cycloalkylamino is a group —NH—R in which R is C₃-C₈-cycloalkyl.

N—C₃-C₈-Cycloalkyl-N—C₁-C₈-alkylamino is a group —N(RR′) in which R is C₃-C₈-cycloalkyl and R′ is C₁-C₈-alkyl.

C₃-C₈-Cycloalkenyl is a monocyclic 3- to 8-membered unsaturated cycloaliphatic radical having at least one double bond. Examples are cyclopropenyl, cyclobutenyl, cyclopentenyl, cyclopentadienyl, cyclohexyl, cyclohexadienyl, cycloheptenyl, cycloheptadienyl, cyclooctyl, cyclooctadienyl, cyclooctatrienyl and cyclooctatetraenyl.

C₃-C₈-Cycloalkenyloxy is a C₃-C₈-cycloalkenyl radical which is bonded via oxygen Examples are cyclopropenyloxy, cyclobutenyloxy, cyclopentenyloxy, cyclopentadienyloxy, cyclohexenyloxy, cyclohexadienyloxy, cycloheptenyloxy, cycloheptadienyloxy, cyclooctenyloxy, cyclooctadienyloxy, cyclooctatrienyloxy and cyclooctatetraenyloxy.

Cₘ-Cₙ-Alkylene is a linear or branched alkylene group having m to n, for example 1 to 8, carbon atoms. Thus, C₁-C₃-alkylene is, for example, methylene, 1,1- or 1,2-ethylene, 1,1-, 1,2-, 2,2- or 1,3-propylene. C₂-C₄-Alkylene is, for example, 1,1- or 1,2-ethylene, 1,1-, 1,2-, 2,2- or 1,3-propylene, 1,1-, 1,2-, 1,3- or 1,4-butylene. C₃-C₅-Alkylene is, for example, 1,1-, 1,2-, 2,2- or 1,3-propylene, 1,1-, 1,2-, 1,3- or 1,4-butylene, 1,1-dimethyl-1,2-ethylene, 2,2-dimethyl-1,2-ethylene, 1,1-, 1,2-, 1,3-, 1,4- or 1,5-pentylene and the like.

Oxy-Cₘ-Cₙ-alkylene is a group —O—R— in which R is Cₘ-Cₙ-alkylene. Thus, oxy-C₂-C₄-alkylene is a group —O—R— in which R is C₂-C₄-alkylene. Examples are oxyethylene, oxypropylene and the like.

Oxy-Cₘ-Cₙ-alkylenoxy is a group —O—R—O— in which R is Cₘ-Cₙ-alkylene. Thus, oxy-C₂-C₄-alkylenoxy is a group —O—R—O— in which R is C₁-C₃-alkylene. Examples are oxymethylenoxy, oxy-1,2-ethylenoxy, oxy-1,3-propylenoxy and the like.

Cₘ-Cₙ-Alkenylene is a linear or branched alkenylene group having m to n, for example 2 to 8, carbon atoms. Thus, C₂-C₄-alkylene is, for example, 1,1- or 1,2-ethenylene, 1,1-, 1,2- or 1,3-propenylene, 1,1-, 1,2-, 1,3- or 1,4-butylene. C₃-C₅-Alkenylene is, for example, 1,1-, 1,2- or 1,3-propenylene, 1,1-, 1,2-, 1,3- or 1,4-butenylene, 1,1-, 1,2-, 1,3-, 1,4- or 1,5-pentenylene and the like.

Oxy-Cₘ-Cₙ-alkenylene is a group —O—R— in which R is Cₘ-Cₙ-alkenylene. Thus, oxy-C₂-C₄-alkenylene is a group —O—R— in which R is C₂-C₄-alkenylene. Examples are oxyethenylene, oxypropenylene and the like.

Oxy-Cₘ-Cₙ-alkenylenoxy is a group —O—R—O— in which R is Cₘ-Cₙ-alkenylene. Thus, oxy-C₂-C₄-alkenylenoxy is a group —O—R—O— in which R is C₂-C₄-alkenylene. Examples are oxyethenylenoxy, oxypropenylenoxy and the like.

C₁-C₄-Alkanols (═C₁-C₄-alcohols) are, for the purposes of the present invention, aliphatic C₁-C₄-hydrocarbons in which one hydrogen atom is replaced by a hydroxyl group. Examples are methanol, ethanol, propanol, isopropanol, n-butanol, sec-butanol, isobutanol and tert-butanol.

Aryl is an optionally substituted aromatic hydrocarbon radical having 6 to 14 carbon atoms, such as phenyl, naphthyl, anthracenyl or phenanthrenyl and in particular phenyl. Examples of suitable substituents are halogen, C₁-C₈-alkyl, C₁-C₈-alkoxy, OH, NO₂, CN, COOH, C₁-C₈-alkylcarbonyl, C₁-C₈-alkylcarbonyloxy, C₁-C₈-alkyloxycarbonyl, NH₂, C₁-C₈-alkylamino, di(C₁-C₈-alkyl)amino and other substituents which are mentioned hereinbelow.

Aryloxy is an aryl radical which is bonded via an oxygen atom. An example is optionally substituted phenoxy.

Arylthio is an aryl radical which is bonded via a sulfur atom. An example is optionally substituted phenylthio.

Aryl-C₁-C₈-alkyl is a C₁-C₈-alkyl radical in which one hydrogen atom is substituted by an aryl group. Examples are benzyl and 2-phenylethyl.

Aryl-C₂-C₈-alkenyl is a C₂-C₈-alkenyl radical in which one hydrogen atom is substituted by an aryl group. An example is 2-phenylethenyl (styryl).

Aryl-C₂-C₈-alkynyl is a C₂-C₈-alkynyl radical in which one hydrogen atom is substituted by an aryl group. An example is 2-phenylethynyl.

Aryl-C₁-C₈-alkoxy is a C₁-C₈-alkoxy radical in which one hydrogen atom is replaced by an aryl group.

Arylthio-C₁-C₄-alkyl is a C₁-C₄-alkyl radical in which one hydrogen atom is replaced by an aryl group, for example optionally substituted phenylthio-C₁-C₄-alkyl. Examples of optionally substituted phenylthio-C₁-C₄-alkyl are phenylthiomethyl (C₆H₅—S—CH₂) and phenylthioethyl (C₆H₅—S—CH₂CH₂), it being possible for the phenyl radical to be substituted, for example by one or more chlorine atoms.

Heterocyclyl is a nonaromatic saturated or unsaturated or aromatic (“hetaryl”) heterocyclyl radical having preferably 3 to 7 ring members and 1, 2, 3 or 4 hetero atoms selected from among O, N and S and/or hetero atom groups selected from among SO, SO₂ and NR, where R is H or C₁-C₈-alkyl as ring members and furthermore if appropriate 1, 2 or 3 carbonyl groups as ring members. Examples of nonaromatic heterocyclyl groups comprise aziridinyl, azetidinyl, pyrrolidinyl, pyrrolidinonyl, pyrrolidinedionyl, pyrazolinyl, pyrazolinonyl, imidazolinyl, imidazolinonyl, imidazolinedionyl, pyrrolinyl, pyrrolinonyl, pyrrolinedionyl, pyrazolinyl, imidazolinyl, imidazolinonyl, tetrahydrofuranyl, dihydrofuranyl, 1,3-dioxolanyl, dioxolenyl, thiolanyl, dihydrothienyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperidinonyl, piperidinedionyl, piperazinyl, pyridinonyl, pyridinedionyl, pyridazinonyl, pyridazinedionyl, pyrimidinonyl, pyridazinedionyl, pyranyl, dihydropyranyl, tetrahydropyranyl, dioxanyl, thiopyranyl, dihydrothiopyranyl, tetrahydrothiopyranyl, morpholinyl, thiazinyl and the like. Examples of aromatic heterocyclyl groups (hetaryl) comprise pyrrolyl, furyl, thienyl, pyrazolyl, imidazolyl, triazolyl, tetrazolyl, oxazolyl, isoxazolyl, thiazolyl, isothiazolyl, thiadiazolyl, oxadiazolyl, pyridyl, pyridazinyl, pyrimidinyl, pyrazinyl and triazinyl.

Heterocyclyloxy or hetaryloxy is a heterocyclyl, or hetaryl, radical which is bonded via an oxygen atom.

Hetaryl-C₁-C₈-alkyl is a C₁-C₈-alkyl radical in which one hydrogen atom is substituted by a hetaryl group. Examples are pyrrolylmethyl, pyridinylmethyl and the like.

Hetaryl-C₂-C₈-alkenyl is a C₂-C₈-alkenyl radical in which one hydrogen atom is substituted by a hetaryl group.

Hetaryl-C₂-C₈-alkynyl is a C₂-C₈-alkynyl radical in which one hydrogen atom is substituted by a hetaryl group.

Hetaryl-C₁-C₈-alkoxy is a C₁-C₈-alkoxy radical in which one hydrogen atom is substituted by a hetaryl group.

The following observations with regard to preferred features of the invention apply by themselves, but also in combination with other preferred features.

“Increase of the quality” preferably means that at least one oil-plant product must meet at least one of the criteria (i) to (xi), more preferably (i) to (viii), even more preferably (i) to (vii), in particular (i) to (iii) and (vi) and specifically (i) or (ii).

Examples of suitable oil crops are oilseed rape, turnip rape, mustard, oil radish, false flax, garden rocket, crambe, sunflower, safflower, thistle, calendula, soybean, lupine, flax, hemp, oil pumpkin, poppy, maize, oil palm and peanut.

The oil crops are preferably selected among seed oil crops.

Seed oil crops are preferably selected among oilseed rape, turnip rape, mustard, oil radish, false flax, garden rocket, crambe, sunflower, safflower, thistle, calendula, soybean, lupine, flax, hemp, oil pumpkin and poppy.

The oil crops/seed oil crops are especially preferably selected among oilseed rape and turnip rape, and in particular oilseed rape.

Preferred in particular for an application in the food and feed sector is 0 oilseed rape and, in particular, 00 oilseed rape. Other types of oilseed rape, for example varieties comprising erucic acid and glucosinolate, are also suitable for other applications.

The fungicides employed in accordance with the invention are selected among aryl- and heterocyclylanilides (hereinbelow also referred to as anilide fungicides), carbamates, dicarboximides, azoles, strobilurins and morpholines. In one embodiment of the invention, the fungicides employed are selected among aryl- and heterocyclylanilides, carbamates, dicarboximides, azoles and strobilurins.

Aryl- and heterocyclylanilides (anilide fungicides) are understood as meaning fungicides which comprise a carboxamide group in which the amine moiety is derived from optionally substituted aniline and the carbonyl group has attached to it an optionally substituted aryl or heterocyclyl radical.

Anilide fungicides and processes for their preparation are, in principle, known to the skilled worker and described, for example, in Farm Chemicals Handbook, Meister Publishing Company or in the Compendium of Pesticide Common Names, http://www.hclrss.demon.co.uk/, which are herewith referred to in their entirety.

Preferred anilide fungicides are those of the formula I

A-CO—NHR¹

in which
A is an aryl group or an aromatic or nonaromatic 5- or 6-membered heterocycle which comprises, as ring members, 1 to 3 heteroatoms or heteroatom-comprising groups selected among O, S, N and NR², R² being hydrogen or C₁-C₈-alkyl, the aryl group or the heterocycle optionally having 1, 2 or 3 substituents which are selected independently of one another among halogen, C₁-C₈-alkyl, C₁-C₈-haloalkyl, C₁-C₈-alkoxy, C₁-C₈-haloalkoxy, C₁-C₈-alkylthio, C₁-C₈-alkylsulfinyl and C₁-C₈-alkylsulfonyl;
R¹ is a phenyl group which optionally has 1, 2 or 3 substituents which are selected independently of one another among C₁-C₈-alkyl, C₂-C₈-alkenyl, C₂-C₈-alkynyl, C₁-C₈-alkoxy, C₂-C₈-alkenyloxy, C₂-C₈-alkynyloxy, C₃-C₈-cycloalkyl, C₃-C₈-cycloalkenyl, C₃-C₈-cycloalkyloxy, C₃-C₈-cycloalkenyloxy, phenyl and halogen, it being possible for the aliphatic and cycloaliphatic radicals to be partially or fully halogenated and/or for the cycloaliphatic radicals to be substituted by 1, 2 or 3 C₁-C₈-alkyl radicals and it being possible for phenyl to be substituted by 1 to 5 halogen atoms and/or by 1, 2 or 3 substituents which are independently of one another selected among C₁-C₈-alkyl, C₁-C₈-haloalkyl, C₁-C₈-alkoxy, C₁-C₈-haloalkoxy, C₁-C₈-alkylthio and C₁-C₈-haloalkylthio and the amidic phenyl group R¹ optionally being fused to a saturated 5-membered ring which is optionally substituted by 1, 2 or 3 C₁-C₈-alkyl groups and/or optionally contains, as ring member, a heteroatom selected among O and S.

Anilides of the formula I and methods for the production thereof are known per se and described for example in EP-A-545099, EP-A-589301 and WO 97/08952 and in the literature cited therein, hereby fully incorporated herein by reference.

The anilide of the formula I is especially preferably selected among anilides of the formula I.1

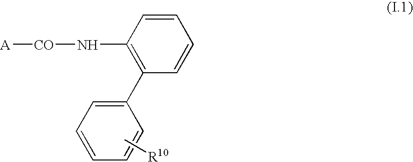

in which A is a group of the formula A1 to A8

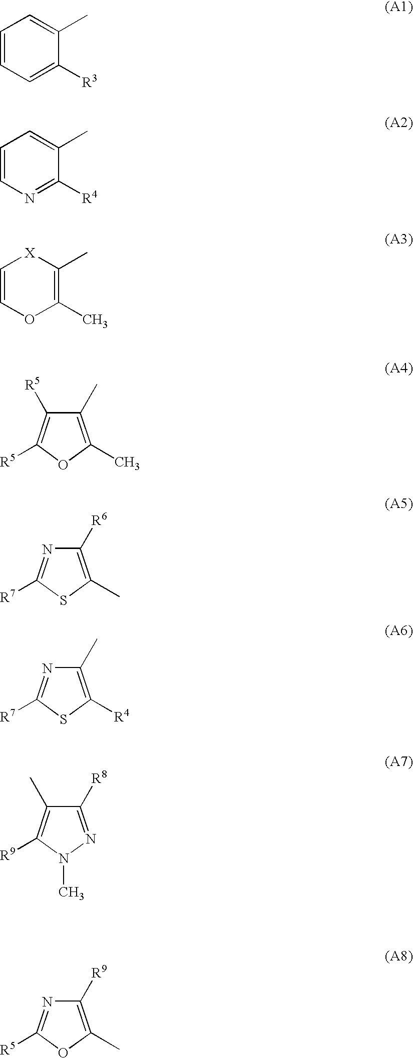

in which
X is CH₂, S, SO or SO₂;
R³ is CH₃, CHF₂, CF₃, Cl, Br or I;
R⁴ is CF₃ or Cl;
R⁵ is hydrogen or CH₃;
R⁶ is CH₃, CHF₂, CF₃ or Cl;
R⁷ is hydrogen, CH₃ or Cl;
R⁸ is CH₃, CHF₂ or CF₃;
R⁹ is hydrogen, CH₃, CHF₂, CF₃ or Cl; and
R¹⁰ is C₁-C₄-alkyl, C₁-C₄-alkoxy, C₁-C₄-alkylthio or halogen.

Group A is preferably the group A2 in which R⁴ is halogen and R¹⁰ is halogen.

In particular, the anilide fungicide of the formula I is selected among anilides of the formula I.1.1 and I.1.2

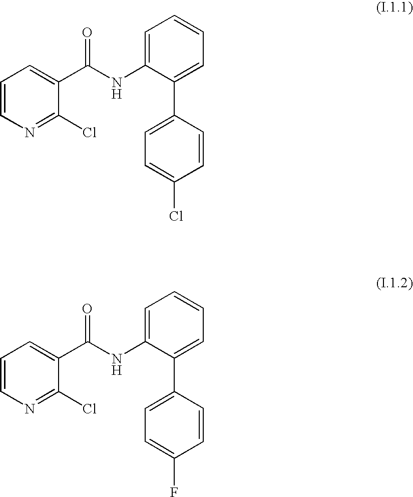

Among these, the anilide I.1.1 is especially preferred. This compound is also known under its common name boscalid and commercially available.

Carbamate fungicides are fungicidally active compounds which comprise a carbamate group (NRR′—CO—OR″).

Carbamate fungicides and methods for the production thereof are, in principle, known to the skilled worker and described for example in Farm Chemicals Handbook, Meister Publishing Company or in the Compendium of Pesticide Common Names, http://www.hclrss.demon.co.uk/, which are herewith referred to in their entirety.

Preferred carbamate fungicides are those which are known under the common names benthiavalicarb, furophanate, iprovalicarb, propamocarb, thiophanate, thiophanate-methyl, thiophanate-ethyl, benomyl, carbendazim, cypendazol, debacarb and mecarbinzid. Among these, carbendazim, thiophanate, thiophanate-methyl and thiophanate-ethyl are especially preferred. In particular, thiophanate-methyl is used.

Dicarboximide fungicides are fungicidally active compounds which comprise an imide group of a dicarboxylic acid. Accordingly, these compounds comprise a cyclic structure having a —CO—NR—CO— group.

Dicarboximide fungicides and methods for the production thereof are, in principle, known to the skilled worker and described for example in Farm Chemicals Handbook, Meister Publishing Company or in the Compendium of Pesticide Common Names, http://www.hclrss.demon.co.uk/, which are herewith referred to in their entirety.

Preferred dicarboximides are those of the formula II

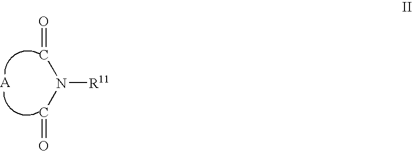

in which
A is —CR¹²R¹³—CR¹⁴R¹⁵—, —CR¹²R¹³—O—, —CR¹²R¹³—NR¹⁶— or —CR¹²═CR¹⁴—,
R¹¹ is C₁-C₈-alkylthio, C₁-C₈-haloalkylthio, C₁-C₈-alkylthio-C₁-C₄-alkyl, C₁-C₈-haloalkylthio-C₁-C₄-alkyl, phenylthio, phenylthio-C₁-C₄-alkyl, phenyl, phenylamino, it being possible for phenyl in the four last-mentioned radicals to be partially or fully halogenated and/or to have attached to it 1 to 3 substituents which are selected among halogen, C₁-C₈-alkyl, C₁-C₈-alkoxy, phenyl and phenoxy, or R¹¹ is di(C₁-C₈-alkyl)phosphonate or di(C₁-C₈-alkyl)thiophosphonate;
R¹², R¹³, R¹⁴ and R¹⁵ independently of one another are hydrogen, halogen, C₁-C₈-alkyl, C₁-C₈-haloalkyl, C₁-C₈-alkoxy, C₁-C₈-alkylthio, C₁-C₈-haloalkoxy, C₁-C₈-haloalkylthio, C₁-C₈-alkoxy-C₁-C₈-alkyl, C₂-C₈-alkenyl, C₂-C₈-alkynyl, carboxyl (═COOH), C₁-C₈-alkyloxycarbonyl, C₁-C₈-alkylcarbonyl, C₁-C₈-alkylcarbonyloxy, phenyl which can be partially or fully halogenated and/or have attached to it 1 to 3 substituents which are selected among halogen, C₁-C₈-alkyl, C₁-C₈-alkoxy, phenyl, phenoxy, benzyl and benzyloxy,
   where
R¹² and R¹⁴ together with the carbon atoms to which they are bonded can also form a 3- to 6-membered saturated or unsaturated aromatic or nonaromatic cycle which can be unsubstituted or substituted by 1 to 3 substituents which are selected among halogen, C₁-C₈-alkyl, C₁-C₈-alkoxy, phenyl, phenoxy, benzyl or benzoxy; and
R¹⁶ is hydrogen, C₁-C₄-alkyl, C₁-C₈-alkylcarbonyl, C₁-C₈-alkyloxycarbonyl or C₁-C₈-alkylaminocarbonyl or di(C₁-C₈-alkyl)aminocarbonyl.

Preferred dicarboximide fungicides are those which are known under the common names famoxadone, fluoroimide, chlozolinate, dichlozoline, iprodione, isovaledione, myclozolin, procymidone, vinclozolin, captafol, captan, ditalimfos, folpet and thiochlorfenphim. Especially preferred are iprodione, vinclozolin and procymidone. In particular, iprodione is used.

Azole fungicides, which are also referred to as conazole fungicides, are fungicidally active compounds which comprise an aromatic 5-membered nitrogen heterocycle and in particular an imidazole ring (“imidazole conazole”) or a triazole ring (“triazole conazole”).

Azole fungicides and methods for the production thereof are, in principle, known to the skilled worker and described for example in Farm Chemicals Handbook, Meister Publishing Company or in the Compendium of Pesticide Common Names, http://www.hclrss.demon.co.uk/, which are herewith referred to in their entirety.

Preferred azole fungicides are those which are known under the common names bitertanol, bromoconazole, cyproconazole, difenoconazole, dinitroconazole, epoxiconazole, fenbuconazole, fluquiconazole, flusilazol, hexaconazole, imazalil, metconazole, myclobutanil, penconazole, propiconazole, prochloraz, prothioconazole, tebuconazole, triadimefon, triadimenol, triflumizol and triticonazole. Especially preferred are flusilazol, metconazole, prothioconazole and tebuconazole. More preferred are flusilazol, metconazole, prothioconazole and tebuconazole. Even more preferred are metconazole, prothioconazole and tebuconazole. In particular, metconazole is used.

Strobilurin fungicides are fungicidally active compounds which are derived from natural strobilurins, defense substances which are produced by fungi of the genus Strobilurus. As regards their structure, they comprise 1.) at least one functional group which is selected among enol ethers, oxime ethers and O-alkylhydroxylamines (group I) and 2.) at least one carboxyl derivative (group II). Preferred carboxyl derivatives are the following functional groups: ester, cyclic ester, amide, cyclic amide, hydroxamic acid and cyclic hydroxamic acid. Preferably, the group I radicals and the group II radicals are directly adjacent to one another, i.e. linked via a single bond.

Strobilurin fungicides are, in principle, known to the skilled worker and described for example in Farm Chemicals Handbook, Meister Publishing Company or in the Compendium of Pesticide Common Names, http://www.hclrss.demon.co.uk/, which are herewith referred to in their entirety.

Preferred strobilurins are those of the formulae IIIA or IIIB

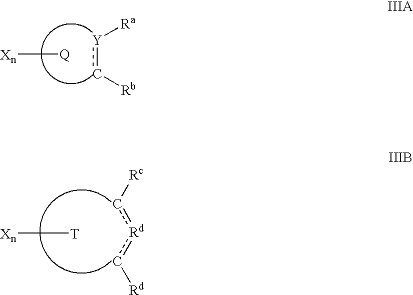

in which
[symbol] is a double bond or single bond;
R^{a} is —C[CO₂CH₃]═CHOCH₃, —C[CO₂CH₃]═NOCH₃, —C[CONHCH₃]═NOCH₃, —C[CO₂CH₃]═CHCH₃, —C[CO₂CH₃]═CHCH₂CH₃, —C[CO₂CH₃]═NOCH₃, —C[COCH₂CH₃]═NOCH₃, —N(OCH₃)—CO₂CH₃, —N(CH₃)—CO₂CH₃ or —N(CH₂CH₃)—CO₂CH₃;
R^{b} is an organic radical which is bonded directly or via an oxygen atom, a sulfur atom, an amino group or a C₁-C₈-alkylamino group; or
   together with a group X and the ring Q or T, to which they are bonded, an optionally substituted bicyclic, partially or fully unsaturated system which, in addition to carbon ring members, may comprise 1, 2 or 3 heteroatoms which are independently selected among oxygen, sulfur and nitrogen;
R^{c} is —OC[CO₂CH₃]═CHOCH₃, —OC[CO₂CH₃]═CHCH₃, —OC[CO₂CH₃]═CHCH₂CH₃, —SC[CO₂CH₃]═CHOCH₃, —SC[CO₂CH₃]═CHCH₃, —SC[CO₂CH₃]═CHCH₂CH₃, —N(CH₃)C[CO₂CH₃]═CHOCH₃, —N(CH₃)C[CO₂CH₃]═NOCH₃, —CH₂C[CO₂CH₃]═CHOCH₃, —CH₂C[CO₂CH₃]═NOCH₃ or —CH₂C[CONHCH₃]═NOCH₃;
R^{d} is oxygen, sulfur, ═CH— or ═N—;
n is 0, 1, 2 or 3, where, if n>1, the radicals X can be identical or different;
X is cyano, nitro, halogen, C₁-C₈-alkyl, C₁-C₈-haloalkyl, C₁-C₈-alkoxy, C₁-C₈-haloalkoxy or C₁-C₈-alkylthio, or
   if n>1, a C₃-C₅-alkylene, C₃-C₅-alkenylene, oxy-C₂-C₄-alkylene, oxy-C₁-C₃-alkylenoxy, oxy-C₂-C₄-alkenylene, oxy-C₂-C₄-alkenylenoxy or butadienediyl group which is bonded to two adjacent C atoms of the phenyl ring, it being possible for these chains, in turn, to have attached to them one to three radicals which are independently of one another selected among halogen, C₁-C₈-alkyl, C₁-C₈-haloalkyl, C₁-C₈-alkoxy, C₁-C₈-haloalkoxy and C₁-C₈-alkylthio;
Y is ═C— or —N—;
Q is phenyl, pyrrolyl, thienyl, furyl, pyrazolyl, imidazolyl, oxazolyl, isoxazolyl, thiazolyl, thiadiazolyl, triazolyl, pyridinyl, 2-pyridonyl, pyrimidinyl or triazinyl; and
T is phenyl, oxazolyl, thiazolyl, thiadiazolyl, oxadiazolyl, pyridinyl, pyrimidinyl or triazinyl.

In particular, the substituent R^{b} takes the form of a C₁-C₈-alkyl, C₂-C₈-alkenyl, C₂-C₈-alkynyl, aryl, hetaryl, aryl-C₁-C₈-alkyl, hetaryl-C₁-C₈-alkyl, aryl-C₂-C₈-alkenyl, hetaryl-C₂-C₈-alkenyl, aryl-C₂-C₈-alkynyl or hetaryl-C₂-C₈-alkynyl radical which is optionally interrupted by one or more groups which are selected among O, S, SO, SO₂, NR(R═H or C₁-C₈-alkyl), CO, COO, OCO, CONH, NHCO and NHCONH or a radical of the formulae defined hereinbelow CH₂ON═CR^{α}CR^{β} or CH₂ON═CR^{γ}CR^{δ}═NOR^{ε}. These radicals optionally also have one or more (preferably 1, 2 or 3) substituents which are independently of one another selected among C₁-C₈-alkyl, C₁-C₈-alkoxy, halogen, cyano, C₁-C₈-haloalkyl (in particular CF₃ and CHF₂), hetaryl and aryl. Hetaryl and aryl, in turn, can have 1, 2 or 3 substituents which are independently of one another selected among halogen, C₁-C₈-haloalkyl (in particular CF₃ and CHF₂), phenyl, CN, phenoxy, C₁-C₈-alkyl, C₁-C₈-alkoxy and C₁-C₈-haloalkoxy.

Such compounds are known and described for example in WO 97/10716 and in the references cited therein, which are herewith incorporated in their entirety.

Preferred strobilurins are those of the formulae IIIA or IIIB in which R^{b} is aryloxy, hetaryloxy, aryloxymethylene, hetaryloxymethylene, arylethenylene or hetarylethenylene, these radicals optionally having 1, 2 or 3 substituents which are independently of one another selected among C₁-C₈-alkyl, halogen, CF₃, CHF₂, CN, C₁-C₈-alkoxy and phenyl which, in turn, can have 1, 2 or 3 substituents which are independently of one another selected among halogen, CF₃, CHF₂, phenyl, CN, phenoxy, C₁-C₈-alkyl, C₁-C₈-alkoxy and C₁-C₈-haloalkoxy;

### or R^{b} is CH₂ON═CR^{α}R^{β} or CH₂ON═CR^{γ}CR^{δ}═NOR^{ε},

where
R^{α} is C₁-C₈-alkyl;
R^{β} is phenyl, pyridyl or pyrimidyl, optionally having 1, 2 or 3 substituents which are independently of one another selected among C₁-C₈-alkyl, C₁-C₈-alkoxy, halogen, C₁-C₈-haloalkoxy, CF₃ and CHF₂;
R^{γ} is C₁-C₈-alkyl, C₁-C₈-alkoxy, halogen, C₁-C₈-haloalkyl or hydrogen;
R^{δ} is hydrogen, cyano, halogen, C₁-C₈-alkyl, C₁-C₈-alkoxy, C₁-C₈-alkylthio, C₁-C₈-alkylamino, di-C₁-C₈-alkylamino, C₂-C₈-alkenyl, C₂-C₈-alkenyloxy, C₂-C₈-alkenylthio, C₂-C₈-alkenylamino, N—C₂-C₈-alkenyl-N—C₁-C₈-alkylamino, C₂-C₈-alkynyl, C₂-C₈-alkynyloxy, C₂-C₈-alkynylthio, C₂-C₈-alkynylamino, N—C₂-C₈-alkynyl-N—C₁-C₈-alkylamino, it being possible for the hydrocarbon radicals of these groups to be partially or fully halogenated and/or to have attached to them 1, 2 or 3 radicals which are independently of one another selected among cyano, nitro, hydroxyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyloxy, C₃-C₈-cycloalkyl, C₃-C₈-cycloalkyloxy, heterocyclyl, heterocyclyloxy, aryl, aryloxy, aryl-C₁-C₈-alkoxy, hetaryl, hetaryloxy and hetaryl-C₁-C₈-alkoxy, it being possible for the cyclic radicals, in turn, to be partially or fully halogenated and/or to have attached to them 1, 2 or 3 groups which are independently of one another selected among cyano, nitro, hydroxyl, C₁-C₈-alkyl, C₁-C₈-haloalkyl, C₃-C₈-cycloalkyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyl and C₂-C₈-alkenyloxy;
   or
   is C₃-C₈-cycloalkyl, C₃-C₈-cycloalkyloxy, C₃-C₈-cycloalkylthio, C₃-C₈-cycloalkylamino, N—C₃-C₈-cycloalkyl-N—C₁-C₈-alkylamino, heterocyclyl, heterocyclyloxy, heterocyclylthio, heterocyclylamino, N-heterocyclyl-N—C₁-C₈-alkylamino, aryl, aryloxy, arylthio, arylamino, N-aryl-N—C₁-C₈-alkylamino, hetaryl, hetaryloxy, hetarylthio, hetarylamino or N-hetaryl-N—C₁-C₈-alkylamino, it being possible for the cyclic radicals to be partially or fully halogenated and/or to have attached to them 1, 2 or 3 groups which are independently of one another selected among cyano, nitro, hydroxyl, C₁-C₈-alkyl, C₁-C₈-haloalkyl, C₃-C₈-cycloalkyl, C₁-C₈-alkoxy, C₁-C₈-haloalkoxy, C₁-C₈-alkoxycarbonyl, C₁-C₈-alkylthio, C₁-C₈-alkylamino, di-C₁-C₈-alkylamino, C₂-C₈-alkenyl, C₂-C₈-alkenyloxy, benzyl, benzyloxy, aryl, aryloxy, hetaryl and hetaryloxy, it being possible for the aromatic radicals in turn to be partially or fully halogenated and/or to have attached to them 1, 2 or 3 of the following groups: cyano, C₁-C₈-alkyl, C₁-C₈-haloalkyl, C₁-C₈-alkoxy, nitro;
R^{ε} is C₁-C₈-alkyl, C₂-C₈-alkenyl or C₂-C₈-alkynyl, it being possible for these groups to be partially or fully halogenated and/or to have attached to them 1, 2 or 3 of the following radicals: cyano, C₁-C₈-alkoxy, C₃-C₈-cycloalkyl.

Particularly preferred compounds of the formula IIIA or IIIB are those in which R^{b} has one of the following meanings:

a) phenyloxymethylene, pyridinyloxymethylene, pyrimidinyloxymethylene or pyrazolyloxymethylene, the aromatic radical optionally having 1, 2 or 3 substituents which are independently of one another selected among C₁-C₈-alkyl, halogen, CF₃, CHF₂, —C(CH₃)═NOCH₃ and phenyl which is optionally substituted by 1, 2 or 3 halogen atoms and/or C₁-C₈-alkyl groups;
b) phenoxy or pyrimidinyloxy which is optionally substituted by 1, 2 or 3 halogen atoms or by a phenoxy radical which optionally has a halogen or cyano substituent;
c) phenylethenylene or pyrazolylethenylene, the phenyl or pyrazolyl radical optionally having 1, 2 or 3 substituents which are independently of one another selected among halogen, CF₃, CHF₂ and phenyl;

### d) CH₂ON═CR^{α}R^{β}

in which
R^{α} is C₁-C₈-alkyl; and
R^{β} is phenyl which optionally has 1, 2 or 3 substituents which are independently of one another selected among C₁-C₈-alkyl, halogen, CF₃ and CHF₂, or is pyrimidinyl which is optionally substituted by 1 or 2 C₁-C₈-alkoxy radicals;
   e) CH₂ON═CR^{γ}CR^{δ}═NOR^{ε}, where
R^{γ} is C₁-C₈-alkyl, C₁-C₈-alkoxy or halogen;
R^{δ} is C₁-C₈-alkyl, cyano, halogen, C₁-C₈-alkoxy, C₁-C₈-alkenyl or phenyl which is optionally substituted by 1, 2 or 3 halogen atoms; and
R^{ε} is C₁-C₈-alkyl.

Especially preferred compounds of the formula IIIA are those in which Q is phenyl and n is 0.

Particularly preferred strobilurins are those which are known under the common names azoxystrobin, dimoxystrobin, fluoxastrobin, kresoxim-methyl, methaminostrobin, orysastrobin, picoxystrobin, pyraclostrobin and trifloxystrobin. More preferred are pyraclostrobin, azoxystrobin and dimoxystrobin. Even more preferred are azoxystrobin and dimoxystrobin, and in particular dimoxystrobin.

Morpholine fungicides are fungicidally active compounds which comprise a morpholine group

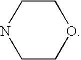

Morpholine fungicides and processes for their preparation are, in principle, known to the skilled worker and described for example in Farm Chemicals Handbook, Meister Publishing Company or in the Compendium of Pesticide Common Names, http://www.hclrss.demon.co.uk/, which are herewith referred to in their entirety.

Preferred morpholine fungicides are those which are known under the common names aldimorph, benzamorf, carbamorph, dimethomorph, dodemorph, fenpropimorph, flumorph and tridemorph. Among these, dimethomorph is especially preferred.

In accordance with the invention, it is also possible to employ a combination of two or more of the abovementioned fungicides which are selected from the same class or from different classes of fungicides. The combined application (in the context of the present invention also referred to as a combination of two or more fungicides) comprises both the use of a mixture of different fungicides and their separate use, it being possible for the fungicides in this case to be used both simultaneously and in succession, i.e. in a time interval of for example a few seconds to several months.

The fungicides to be employed in accordance with the invention are preferably selected among aryl- and/or heterocyclylanilides, strobilurins and azoles. As regards suitable and preferred representatives of these classes of fungicides, reference is made to what has been said above. Also preferred is the combined use of at least two representatives of these classes of fungicides.

In a preferred embodiment of the invention, the fungicide used is at least one aryl- and/or heterocyclylanilide. As regards suitable and preferred anilides, reference is made to what has been said above. The anilide fungicide used is, in particular, boscalid.

In another preferred embodiment of the invention, the fungicide used is at least one azole. As regards suitable and preferred azoles, reference is made to what has been said above. The azole fungicide used is preferably metconazole, prothioconazole or tebuconazole or their combination. The azole fungicide used is, in particular, metconazole.

In an alternatively preferred embodiment of the invention, at least one strobilurin is used as the fungicide. As regards suitable and preferred strobilurins, reference is made to what has been said above. Azoxystrobin or dimoxystrobin or their combination are preferably used as the strobilurin fungicide. In particular, dimoxystrobin is used as the strobilurin fungicide.

In another preferred embodiment of the invention, at least one aryl- or heterocyclylanilide fungicide is used in combination with at least one azole fungicide. The preferred anilide fungicide in this context is boscalid. The preferred azole fungicide is metconazole.

In an alternatively preferred embodiment of the invention, at least one aryl- or heterocyclylanilide fungicide is used in combination with at least one strobilurin fungicide. The preferred anilide fungicide in this context is boscalid. The preferred strobilurin fungicide is dimoxystrobin.

Specifically at least one aryl- or heterocyclylanilide is used as fungicide, especially boscalid, if appropriate in combination with at least one azole fungicide, especially with metconazole, or, if appropriate, in combination with at least one strobilurin fungicide, especially with dimoxystrobin, or else at least one azole fungicide is used, especially metconazole.

In general, the fungicides employed in accordance with the invention for increasing the quality and, if appropriate, the quantity of oil crop products or for reducing the brittleness of seed coats of seed oil crops are used in such a way that the oil crops or plant parts thereof, or the seed of the oil crops, are treated with these compounds. The treatment of the oil crops or of the seed is preferably effected in such a way that the oil crop or plant parts thereof or the seed are brought into contact with at least one of the fungicides employed in accordance with the invention. To this end, at least one fungicide is applied to the plant or to plant parts thereof or to the seed. If a plurality of fungicides used in accordance with the invention are combined, they can be applied as a mixture or separately. In the case of separate application, the application of the individual active substances can be effected simultaneously or split within the context of a series of treatments; in the case of successive application, they can be applied at intervals of from a few seconds or a few minutes to several weeks or even a few months, for example up to 10 months. It is also possible repeatedly to apply a single active substance, for example in a time interval between the individual applications of from a few seconds or a few minutes to several weeks or even several months, for example up to 10 months.

The application timing, the number of applications and the application rates applied in each case are to be adapted to the prevailing conditions and must be decided by the skilled worker for each individual case. Apart from the active substances used in each case, a differentiation must be made in particular as to whether intact plants are to be treated under field conditions or whether seed is to be treated.

The active substances, as such or in the form of their formulations or in the form of the use forms prepared therefrom, can be applied by spraying, atomizing, nebulizing, dusting, scattering or pouring. The use forms depend entirely on the intended use, in particular on the plant species and variety and/or on the plant part or plant product, to which they are to be applied; in any case, they should ensure as fine as possible a distribution of the active substances employed in accordance with the invention and also of the auxiliaries.

The fungicides used in accordance with the invention are typically employed in the form of formulations as are customary in the field of crop protection and the protection of stored products.

Examples of customary formulations are solutions, emulsions, suspensions, dispersions, pastes, dusts, materials for spreading, powders and granules.

The formulations are prepared in the known manner, for example by diluting the active substance with solvents and/or carriers, if desired using emulsifiers and dispersants. Suitable solvents/auxiliaries are mainly:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, dimethyl fatty amides, fatty acids and fatty acid esters. In principle, it is also possible to use solvent mixtures.
Carriers such as natural minerals (for example kaolins, clays, talc, chalk) and ground synthetic minerals (for example highly disperse silica, silicates).
Surface-active substances, such as alkali metal, alkaline earth metal, ammonium salts of aromatic sulfonic acids, for example lignosulfonic acid, phenolsulfonic acid, naphthalenesulfonic acid and dibutylnaphthalenesulfonic acid and of fatty acids, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol or nonylphenol, alkylphenyl polyglycol ether, tributylphenyl polyglycol ether, tristearylphenyl polyglycol ether, alkylaryl polyether alcohols, isotridecyl alcohol, alcohol and fatty alcohol/ethylene oxide condensates, ethoxylated castor oil, polyoxyethylene or polyoxypropylene alkyl ethers, ethoxylated polyoxypropylene, lauryl alcohol polyglycol ether acetate, sorbitol esters, lignin-sulfite waste liquors, methylcellulose or siloxanes. Examples of suitable siloxanes are polyether/polymethylsiloxane copolymers, which are also referred to as “spreaders” or “penetrants”.

Inert formulation auxiliaries, in particular for the preparation of directly sprayable solutions, emulsions, pastes or oil dispersions, which are suitable are essentially: mineral oil fractions of medium to high boiling point, such as kerosene or diesel oil, furthermore coal tar oils, and oils of vegetable or animal origin, aliphatic, cyclic and aromatic hydrocarbons, for example toluene, xylenes, paraffins, tetrahydronaphthalene, alkylated naphthalenes or their derivatives, alcohols such as methanol, ethanol, propanol, butanol and cyclohexanol, ketones such as cyclohexanone and isophorone, strongly polar solvents, for example dimethyl sulfoxide, N-methylpyrrolidone or water.

Powders, materials for spreading and dusts can be prepared by mixing or concomitantly grinding the active substances together with a solid carrier.

Granules, for example coated granules, impregnated granules and homogeneous granules, can be prepared by binding the active substances to solid carriers.

Examples of solid carriers are mineral earths such as silica gels, silicates, talc, kaolin, Attaclay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and products of vegetable origin, such as cereal meal, tree bark meal, wood meal and nutshell meal, cellulose powders and other solid carriers.

In general, the formulations comprise the fungicides employed in accordance with the invention in a total amount of from 0.01 to 95% by weight, preferably of from 0.1 to 90% by weight, based on the total weight of the formulation.

Products (formulations) for dilution in water are, for example, water-soluble concentrates (SL), dispersible concentrates (DC), emulsifiable concentrates (EC), emulsions (EW, EO), suspensions (SC, OD, SE), water-dispersible and water-soluble granules (WG, SG) and water-dispersible and water-soluble powders (WP, SP). Products (formulations) for the direct application are, for example, dusts (DP), granules (GR, FG, GG, MG) and ULV solutions (UL).

Aqueous use forms can be prepared from stock formulations, such as concentrated solutions, emulsion concentrates, suspensions, pastes, wettable powders (sprayable powders, oil dispersions) or water-dispersible granules by addition of water and applied for example by spraying.

To prepare emulsions, pastes or oil dispersions, the fungicides employed in accordance with the invention, as such or dissolved in an oil or solvent, can be homogenized in water by means of wetters, stickers, dispersants or emulsifiers. However, it is also possible to prepare concentrates which consist of the active substance, wetters, stickers, dispersants or emulsifiers and, if appropriate, solvent or oil, and such concentrates are suitable for dilution with water. Naturally, the use forms will comprise the auxiliaries used in the stock formulations.

The active substance concentrations in preparations which are diluted with water can vary within substantial ranges. They are in general between 0.0001 and 10% by weight, preferably between 0.01 and 1% by weight.

Various types of oils, and wetters, safeners, adjuvants, other fungicides, insecticides, bactericides, growth regulators or else foliar fertilizers comprising, for example, trace elements and/or oligoelements, can be added to the active substances, if appropriate also immediately before application (tank mix). These agents can also be applied separately to the fungicides employed in accordance with the invention, it being possible to carry out the separate application before, simultaneously with, or after the application of the fungicides. These agents can be admixed to the fungicides employed in accordance with the invention in a weight ratio of 1:200 to 200:1, preferably 1:100 to 100:1.

The combined use of the fungicides employed in accordance with the invention with further active substances conventionally used in crop protection, for example with other fungicides, can be effected by employing a mixture of these active substances (for example a joint formulation or tank mix), or else by applying the individual active substances separately, simultaneously or in succession.

When the fungicides used in accordance with the invention are employed in combination with at least one of the abovementioned agents, their use in combination with at least one fungicide other than the above is particularly suitable.

The following list of fungicides with which the fungicides employed in accordance with the invention can be used jointly is intended to illustrate the possible combinations, but not to impose any limitation:
acylalanines such as benalaxyl, metalaxyl, ofurace, oxadixyl,
amine derivatives such as aldimorph, dodine, dodemorph, fenpropimorph, fenpropidin, guazatine, iminoctadine, spiroxamin, tridemorph
anilinopyrimidines such as pyrimethanil, mepanipyrim or cyprodinyl,
antibiotics such as cycloheximide, griseofulvin, kasugamycin, natamycin, polyoxin or streptomycin,
dithiocarbamates such as ferbam, nabam, maneb, mancozeb, metam, metiram, propineb, polycarbamate, thiram, ziram, zineb,
heterocyclic compounds such as anilazin, cyazofamide, dazomet, dithianone, fenamidon, fenarimol, fuberidazol, isoprothiolan, nuarimol, probenazol, proquinazide, pyrifenox, pyroquilon, quinoxyfen, silthiofam, thiabendazol, tricyclazol, triforine,
copper fungicides such as Bordeaux mixture, copper acetate, copper oxychloride, basic copper sulfate,
nitrophenyl derivatives such as binapacryl, dinocap, dinobuton, nitrophthal-isopropyl,
phenylpyrroles such as fenpiclonil or fludioxonil,
sulfur,
other fungicides such as acibenzolar-S-methyl, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, fosetyl, fosetyl-aluminum, hexachlorobenzene, metrafenon, pencycuron, phthalide, toloclofos-methyl, quintozene, zoxamide,
cinnamamides and analogs such as dimethomorph, flumetover or flumorph.

The fungicides employed in accordance with the invention are preferably applied to the oil crop or to parts thereof. Naturally, the treatment is carried out on a live plant, that is to say during the vegetation phase of the plant. The application is preferably effected on the aerial part of the plant.

In an embodiment which is preferred for field applications, i.e. the application to growing plants or plant parts thereof, the fungicides employed in accordance with the invention are used in the form of an aqueous spray mixture. The application is preferably effected by spraying. Here, either all of the aerial part of the plant or only individual plant parts, such as flowers, fruits, leaves or individual shoots, are treated. The choice of the individual plant parts which are to be treated depends on the plant species and its developmental stage. It is preferred to treat all of the aerial part of the plant.

When carrying out the field application, the fungicides employed in accordance with the invention are generally employed in an amount of from 5 to 3000 g of individual active substance per ha per season, preferably from 10 to 1000, particularly preferably from 50 to 500 g of individual active substance per ha per season.

The fungicides employed in accordance with the invention are preferably applied 1 to 5 times, especially preferably 1 to 3 times and in particular once or twice per season.

In the case of seed, the fungicides employed in accordance with the invention are used in a formulation conventionally used for this type of application.

When applying to seed, the fungicides employed in accordance with the invention are generally employed in an amount of from 0.01 g to 500 g, preferably 0.5 g to 200 g, of individual active substance per kg of seed.

A further subject matter of the present invention is a method of increasing the quality and, if appropriate, the quantity of oil crop products, comprising the treatment of an oil crop or of plant parts thereof during the vegetation phase of the plant, or its seed, with at least one of the abovementioned fungicides, and obtaining the oil crop products.

The increase in quality and, if appropriate, the quantity of oil crop products is as defined above.

The vegetation phase of the plants is understood as meaning the interval from emergence to harvesting.

As regards suitable and preferred oil crops, oil crop products and fungicides, and the amount and type of the application, reference is made to what has been said above.

The treatment of the oil crop or plant parts thereof during the vegetation phase of the plant is preferred. In this context, the oil crop is preferably treated at least to some extent during the flowering phase, i.e. at least one fungicide is applied during the flowering phase and, if appropriate, the same fungicide or a different fungicide is employed during a different vegetation period. If a plurality of fungicides to be employed in accordance with the invention are combined, it is preferred to employ one fungicide during the flowering phase and the other fungicide(s) before the flowering phase, for example in spring and/or in the autumn. If for example anilide fungicides are combined with azole fungicides, it is preferred to apply the anilide fungicide(s) in the flowering phase and the azole fungicide(s) at an earlier point in time, for example in spring and/or in the autumn.

Obtaining oil from the oil-yielding parts of the plant, which are the seeds, fruits, and/or nuts of the oil crop, is accomplished in the manner conventionally used for the plant or plant product in question, for example by pressing and/or by extracting. The skilled worker is sufficiently familiar with the pre- or aftertreatment measures required in each case for the individual plants or their plant products.

Obtaining the oil by pressing generates, as residue, what is known as the presscake which, in turn, can be used, for example, as feed or fuel.

The use according to the invention of the above-described fungicides, or the method according to the invention preferably result in a reduced phosphorus content of the products of the treated plants, in particular of the oil obtained from the oil crops and/or of the reaction products of this oil, for example its C₁-C₄-alkyl esters.

Alternatively, or additionally, the use according to the invention of the above-described fungicides and/or the method according to the invention, result in a reduced alkali metal and/or alkaline earth metal content, especially the alkaline earth metal content and specifically the calcium and magnesium content of the products of the treated plants, in particular of the oil obtained from the oil crops and/or of the reaction products of this oil, for example its C₁-C₄-alkyl esters.

Alternatively, or additionally, the use according to the invention of the above-described fungicides, or the method according to the invention, result in a reduction of the acid content (measured as acid number) of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the iodine number of the products of the treated plants, in particular of the oil obtained from the oil crops and/or of the reaction products thereof, for example its C₁-C₄-alkyl esters.

Alternatively, or additionally, the use according to the invention of the above-described fungicides, or the method according to the invention, result in an increase of the resistance to oxidation of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the overall contamination of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the kinematic viscosity of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the sulfur content of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in an increase of the flashpoint of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in an increase of the calorific value of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the coke residue of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in an increase of the cetane number of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the nitrogen content of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the chlorine content of the products of the treated plants, in particular of the oil obtained from the oil crops and, if appropriate, of the reaction products thereof, for example its C₁-C₄-alkyl esters.

Alternatively, or additionally, the use according to the invention of the above-described fungicides, or the method according to the invention, result in a reduction of the tin, zinc, silicon and/or boron content of the products of the treated plants, in particular of the oil obtained from the oil crops and, if appropriate, of the reaction products thereof, for example its C₁-C₄-alkyl esters.

The use according to the invention of the above-described fungicides, or the method according to the invention, especially preferably leads to an improvement of the properties of the products of the treated plants, which properties have been mentioned under (i) to (xi) more preferably (i) to (viii) and in particular (i) to (vii), in particular of the oil obtained from the oil crops and, if appropriate, of the reaction products thereof, for example its C₁-C₄-alkyl esters.

The use according to the invention of the above-described fungicides, or the method according to the invention, especially preferably leads to a reduction in the phosphorus content and/or the alkali metal and/or alkaline-earth metal content, in particular to a reduction in the phosphorus content, of the products of the treated plants, in particular of the oil obtained from the oil crops and/or of the reaction products thereof, for example its C₁-C₄-alkyl esters. Accordingly, the method according to the invention particularly preferably serves to prepare oil-plant products, in particular vegetable oil and/or reaction products thereof, for example its C₁-C₄-alkyl esters, with a reduced phosphorus content and/or alkali metal and/or alkaline-earth metal content and in particular with a reduced phosphorus content.

The acid content of the oil-plant products, especially of the oil and, if appropriate, of its reaction products, can be determined for example as specified in DIN EN 14104 (as acid number). The resistance to oxidation can be measured as specified in DIN EN 14112. The phosphorus content can be determined as specified in DIN EN 14107, and the alkali metal (mainly Na and K) and alkaline-earth metal content (calcium and magnesium) as specified in DIN EN 14538. The iodine number can be determined as specified in EN 14111. The overall contamination can be measured for example as specified in EN 12662. The kinematic viscosity can be determined for example as specified in EN ISO 3104. The flashpoint can be determined as specified in EN ISO 2719, the net calorific value as specified in DIN 51900-1 and -3, the Conradson coke residue as specified in EN ISO 10370, and the cetane number as specified in DIN 51773. The sulfur content can be determined as specified in EN ISO 20884 and the chlorine content as specified in DIN 51577-3. Tin, zinc and silicon contents can be measured as specified in DIN 51396-1, and the boron content can be measured as specified in DIN 51443-2.

The terms “phosphorus content”, “alkali metal content”, “alkaline-earth metal content”, “acid content/acid number”, “iodine number”, “resistance to oxidation”, “overall contamination”, “kinematic viscosity”, “flashpoint”, “net calorific value”, “coke residue”, “cetane number”, “sulfur content”, “chlorine content” and “zinc, tin, silicon and boron content” are preferably defined as in the corresponding standards for determining their magnitude.

The increase in the quality of the oil crop products which is expressed for example in a reduction of the phosphorus content, and/or of the alkali metal content and/or alkaline earth metal content and/or of the acid content and/or in the increase in the resistance to oxidation etc., can probably be attributed at least in part to a systemic activity of the fungicides employed in accordance with the invention, which activity brings about the reduction for example in the phosphorus content and/or in the alkali metal/alkaline earth metal content and/or the acid content and/or the content of unsaturated fatty acids of the oil-comprising plant products, i.e. of the fruits, seeds and/or nuts and/or increases the content of natural antioxidants. Thus, the phosphorus content, the alkali metal/alkaline earth metal content and/or the acid content etc. of the oil and presscake obtained therefrom and of the reaction products of the oil is also reduced, and/or the resistance to oxidation increases.

The reduction in the content of phosphorus compounds and/or of alkali metal and especially alkaline earth metal compounds, but also of suspended matter (which is determined as overall contamination) and other undesired components, can, in particular in the case of seed oil crops, also probably be attributed inter alia to the fact that the use according to the invention of fungicides leads to a reduced brittleness of the seed coats of seed oil crops. As a result, the seed coats are less fragile and are comminuted to a lesser degree during pressing for obtaining the oil, so that fewer constituents of the seed coat are extracted. The reduced brittleness, i.e. the increased elasticity, of the seed coat permits the use of lower pressures when pressing the oil-comprising plant products, which equally leads to a reduced extraction of undesired components from the seed coat. In turn, when applying a higher pressing pressure and/or a higher pressing temperature, a particular limit for the quality of the oil (for example the phosphorus limit) can be adhered to, while the oil yield can be increased significantly as a result of the harsher pressing conditions. This means that, in the specific case of oil, the use of the above-described fungicides leads not only to increased quality, but also to increased quantity.

A further subject of the invention is a method for reducing the brittleness of the seed coats of seed oil crops, in which a seed oil crop or plant parts thereof during the vegetation phase of the plant or its seed are treated with at least one of the abovementioned fungicides.

Again, as regards suitable and preferred seed oil crops and fungicides and the way and amount in which they are employed, reference is made to what has been said above.

Preference is given to the treatment of the oil crop or plant parts thereof during the vegetation phase of the plant. As regards preferred timings of the treatment, reference is made to what has been said above.

The invention also relates to seeds from seed oil crops, which seeds can be obtained from seed oil crops which have been treated in accordance with the invention. In comparison with seeds which have been obtained from seed oil crops which have not been treated according to the invention, the former are preferably distinguished by reduced brittleness of the seed coat. Moreover, they are preferably distinguished by the fact that the oil obtained from them, and the reaction products of this oil, have at least one of the properties mentioned under (i) to (xv) and preferably have a reduced acid number and/or an increased resistance to oxidation. Alternatively or additionally, they are distinguished preferably by a reduced phosphorus content and/or a reduced alkali metal and/or in particular alkaline earth metal content.

The present invention furthermore relates to an oil crop product which is obtainable by the method according to the invention. This is distinguished inter alia by at least one of the properties mentioned under (i) to (xv), preferably by a reduced phosphorus content and/or a reduced content of alkali metal and especially alkaline earth metal compounds. In addition or alternatively, it is distinguished preferably by a reduced acid content and/or an increased resistance to oxidation.

The oil crop products are preferably selected among the oil-comprising fruits and seeds of oil crops, the oil obtained therefrom, the presscake which is generated when obtaining oil by the pressing method, and the reaction products of the oil, for example its transesterification products with C₁-C₄-alcohols.

Oil-comprising fruits can firstly be employed as foodstuffs or feeds. Secondly, they can be employed for obtaining oil. They are preferably employed for obtaining oil.

The oil-comprising seeds preferably take the form of the seeds of seed oil crops. The oil-comprising seeds of oil crops, in particular of seed oil crops, can firstly be employed as foodstuffs or feeds. Alternatively, they can be employed for obtaining oil. They are also suitable for the direct use as a source of energy, i.e. as fuel, especially in furnace installations. They are preferably employed for obtaining oil or as a direct source of energy, i.e. as fuel, in particular for obtaining oil.

As has already been said above, the seeds according to the invention are distinguished over seeds obtained from untreated seed oil crops inter alia by a reduced phosphorus content and/or a reduced alkali metal and especially alkaline earth metal content and a reduced brittleness of the seed coat and in particular by a reduced phosphorus content and a reduced brittleness of the seed coat. The oil (and its reaction products) obtained from the seeds has in particular increased resistance to oxidation and/or a reduced acid number and/or a reduced phosphorus content and/or a reduced alkali metal and/or alkaline earth metal content in comparison with oils obtained from plants which have not been treated in accordance with the invention. In addition or alternatively, the oil obtained according to the invention is distinguished by at least one property mentioned under (iv), (v) and (vii) to (xv), for example by a lower iodine number, a lower kinematic viscosity and/or a lower overall contamination and the like (in comparison with oils which have been obtained from plants which have not been treated according to the invention).

The oil obtained from the fruits and/or seeds of oil crops treated in accordance with the invention can be employed in the food sector, for example as edible oil or for the preparation of margarine, in the cosmetics sector, for example as carrier, as lubricant or as energy source, i.e. as fuel including motor fuel. When the oil obtained is used in the food sector, it may have to be subjected to further refining steps in order to eliminate any undesired flavors, aroma substances, colors, inedible components and the like.

The oil is preferably employed as fuel, including motor fuel.

The oil according to the invention is distinguished, inter alia, by a reduced acid content and/or improved resistance to oxidation and/or a reduced phosphorus content and/or a reduced content of alkali metal and especially alkaline earth metal compounds and/or a reduced content of suspended matter and other interfering components in comparison with oils obtained from untreated oil crops. In addition or alternatively, the oil according to the invention is distinguished by at least one property mentioned under (iv), (v) and (vii) to (xv), for example by a lower iodine number, a lower kinematic viscosity and/or a lower overall contamination and the like (in comparison with oils which have been obtained from plants which have not been treated according to the invention).

The reaction products of the oil preferably take the form of its reaction products with C₁-C₄-alcohols, i.e. the C₁-C₄-alkyl esters of the fatty acids on which the oils are based. Especially preferably, they take the form of the transesterification products of the oil with methanol or ethanol and in particular with methanol, i.e. the form of the methyl or ethyl esters and in particular the methyl esters of the fatty acids on which the oils are based. The C₁-C₄-alkyl esters are obtainable by transesterifying the vegetable oil with a C₁-C₄-alcohol, usually in the presence of a catalyst (generally a base). During this process, the fatty acid triglycerides of the oil are converted into the C₁-C₄-alkyl esters of the fatty acids in question. These esters are referred to as C₁-C₄-alkyl esters of the vegetable oil, for the purposes of the present invention.

The reaction products of the oil and in particular its transesterification products with C₁-C₄-alcohols are especially suitable for use as an energy source, i.e. as fuel including motor fuel.

The reaction products according to the invention of the oil, and in particular the C₁-C₄-alkyl esters of the oil, are distinguished by the properties mentioned for the oil.

When pressing the fruits and/or seeds of oil crops, the residue obtained is a presscake which, like the fruits and seeds, is distinguished by a reduced content of phosphorus and/or alkali metal and especially alkaline earth metal compounds and in particular by a reduced phosphorus content. The acid content may also be reduced. This presscake can be employed not only in the feed sector, but also as a direct source of energy, i.e. as fuel, especially in furnace installations, the use as energy source being preferred.

The oil crop products are especially preferably selected among seeds, vegetable oils and their reaction products, for example the transesterification products with C₁-C₄-alcohols. The oil crop products are, in particular, selected among oils and their reaction products, for example the transesterification products with C₁-C₄-alcohols.

The present invention furthermore relates to a renewable fuel which comprises an oil according to the invention and/or at least one transesterification product thereof with a C₁-C₄-alkanol.

For the purposes of the present invention, renewable fuels are fuels which comprise at least 1% by weight, preferably at least 5% by weight, more preferably at least 10% by weight, even more preferably at least 20% by weight and in particular at least 50% by weight of biodiesel and/or vegetable oils, based on the total weight of the fuel. Specifically, the renewable fuel consists in its entirety of biodiesel and/or vegetable oils. If the renewable fuel does not consist in its entirety of biodiesel and/or vegetable oils, it comprises, in addition to biodiesel and/or vegetable oils, a further fuel which may for example be renewable, such as BTL fuels (biomass to liquid), or else mineral, such as mineral fuels, for example middle distillates, such as diesel, heating oil or kerosene.

For the purposes of the present invention, fuels are understood as meaning substances which can be burnt economically with atmospheric oxygen while releasing utilizable energy, for example in the form of heat. The heat can then be either exploited directly, for example in boilers or heating systems, it can be employed for the generation of electricity or it can be converted into kinetic energy, for example for operating engines. The fuels thus include for example heating oils and motor fuels. Motor fuels are fuels which are used for operating internal combustion engines, such as Otto engines or diesel engines, for example Otto fuels, diesel fuels, kerosene and the like.

Biodiesel is generally understood as meaning the lower-alkyl esters of vegetable oils (or else animal fats), i.e. their C₁-C₄-alkyl esters, in particular their ethyl or methyl esters and specifically their methyl esters.

The lower-alkyl esters are used or admixed to the vegetable oils in particular when the high viscosity of the vegetable oil is a problem.

Accordingly, the renewable fuel according to the invention is a mixture of the vegetable oil according to the invention and/or its C₁-C₄-alkyl esters with a mineral fuel, for example mineral diesel fuel or mineral heating oil, or other conventional or renewable fuels, or it consists essentially completely of the vegetable oil according to the invention and/or its C₁-C₄-alkyl esters.

The transesterification of the vegetable oil according to the invention with C₁-C₄-alcohols to give the C₁-C₄-alkyl esters thereof can be accomplished in accordance with current methods. The C₁-C₄-alkyl esters of the oils according to the invention are likewise subject matter of the invention.

Finally, the invention relates to a method of improving the combustion in engines and furnace installations, in which the engines or the furnace installations are operated at least to some extent with a suitable oil crop product according to the invention.

Furnace installations are understood as meaning all systems in which suitable fuels are burnt for the direct or indirect generation of energy, for example in the form of heat, steam and/or electricity.

The engines are generally engines which can be operated, in principle, with renewable fuels. They include especially diesel engines, for example diesel engines in passenger cars, trucks, buses and agricultural vehicles such as tractors or else in communal heating systems.

It is preferred to operate the engines with the renewable fuel according to the invention. Naturally, in the event that the renewable fuel also comprises mineral fuels in addition to biodiesel and/or vegetable oils, the former will be selected among mineral motor fuels, for example mineral diesel fuels.

The furnace installations can be operated with the renewable fuel according to the invention, with the presscake according to the invention and/or with the oil-comprising seeds according to the invention.

The operation according to the invention of engines and furnace installations extends their service life and simplifies maintenance.

Treating oil crops with the above-specified fungicides gives oil crop products whose quality is higher than that of oil crop products from oil crops not treated in accordance with the invention. In particular, they are distinguished by a lower acid content and/or increased resistance to oxidation (in particular in the case of oil and its reaction products) and/or also by a lower phosphorus content and/or lower alkali metal/alkaline earth metal content. The vegetable oils and their reaction products additionally also comprise markedly smaller amounts of other components which interfere with the use of the vegetable oils in the biodiesel sector. Moreover, the kinematic viscosity of the vegetable oils is reduced, which is an advantage for the use of the oils themselves as renewable fuels. Moreover, the treatment with the abovementioned fungicides leads, in particular in the case of seed oil crops, to a reduced brittleness of the seed coat, which firstly permits the use of lower pressures for obtaining the oil from the seed and secondly makes it possible to adhere to limits regarding the content of certain substances, for example phosphorus compounds, even when using high pressing pressures. The improved properties of the oil-crop products, in particular of the oil or its reaction products, lead, in total, to improved economical possibilities of using renewable fuels, including motor fuels. The fact that the improved properties of the oils or their reaction products permit lower blending with more low-quality fuels, including motor fuels, is mentioned by way of example only.

The invention is now illustrated by the following nonlimiting examples.

### EXAMPLES

### 1. Phosphorus Content and Alkaline-Earth Metal Content of Oil

1.1 Phosphorus Content and Alkaline-Earth Metal Content of Oil in the Treatment of Oilseed Rape with Metconazole on Pressing with Normal Pressure

Oilseed rape was grown in 2004/2005 in Germany under the usual conditions. In autumn 2004 (growth stage BBCH 14-16) and in spring 2005 (growth stage BBCH 31-51), some of the oilseed rape was treated by spraying with metconazole (employed in the form of the commercially available product Caramba®; application rate: in each case 60 g active ingredient per ha). For comparison purposes, the remainder of the oilseed rape remained untreated. The plants were harvested in summer 2005 (growth stage BBCH 92). The rapeseed was pressed with a press from Ökotec under normal pressure (nozzle 8, 40 rpm, temperature at the pressing head 60° C.), and the phosphorus content and the alkaline-earth metal content (Ca, Mg) of the resulting oil were determined in accordance with DIN EN 14107 and DIN EN 14538, respectively. The results are shown in the table which follows.

TABLE 1

| | Treatment | |
|---|---|---|
| | Untreated | 2 × metconazole |
| Phosphorus content [mg/kg] | 1.9 | <1 |
| Alkaline-earth metal content (Ca + Mg) | 5.7 | 3.9 |
| [mg/kg] | | |

1.2 Phosphorus Content of Oil when Treating Oilseed Rape with Metconazole or Metconazole in Combination with Boscalid, and Pressing at High Pressure.

Oilseed rape cv. “Trabant” was grown under the usual conditions in 2005/2006 in Germany at the Bothkamp site. In autumn 2005 (growth stage BBCH 16-18) and in spring 2006 (BBCH 31-51), some of the oilseed rape plants were treated by spraying with metconazole (employed in the form of the commercially available product Caramba®; application rate: in each case 60 g active ingredient per ha). Some other oilseed rape plants were furthermore additionally treated during anthesis (BBCH 65) by spraying with boscalid (employed in the form of the commercially available product Cantus®; application rate: 250 g active substance per ha). For comparison reasons, some of the rapeseed plants remained untreated. The plants were harvested in summer 2006 (growth stage BBCH 92). The rapeseed was pressed with a press from Ökotec under high pressure (nozzle 6, 70 rpm, temperature at the pressing head >70° C.), and the phosphorus content of the resulting oil was determined in accordance with DIN EN 14107. The results are shown in the table which follows.

TABLE 2

| | | Treatment | |
|---|---|---|---|
| | | | 2 × metconazole; |
| | Untreated | 2 × metconazole | 1 × boscalid |
| Phosphorus content | 5.0 | 4.0 | 3.0 |
| [mg/kg] | | | |

1.3 Alkaline-Earth Metal Content of Oil in the Treatment of Oilseed Rape with Metconazole and Pressing with Normal Pressure and High Pressure

Oilseed rape cv. “Trabant” was grown under the usual conditions in 2005/2006 in Germany at the Bothkamp site. In autumn 2005 (growth stage BBCH 16-18) and in spring 2006 (BBCH 31-51), some of the oilseed rape plants were treated by spraying with metconazole (employed in the form of the commercially available product Caramba®; application rate: in each case 60 g active ingredient per ha). For comparison reasons, the remainder of the rapeseed plants remained untreated. The plants were harvested in summer 2006 (growth stage BBCH 92). The rapeseed was pressed with a press from Ökotec and the alkaline-earth metal content (Ca, Mg) of the resulting oil was determined as specified in DIN EN 14538. Here, part of the rapeseed was pressed under normal pressure (nozzle 8, 40 rpm, temperature at the pressing head 60° C.) and another portion under high pressure (nozzle 6, 70 rpm, temperature at the pressing head >70° C.). The results are shown in the table which follows.

TABLE 3

| | Treatment | |
|---|---|---|
| | Untreated | 2 × metconazole |
| Alkaline-earth metal content (Ca + Mg) | 6 | 4 |
| [mg/kg] - normal pressure | | |
| Alkaline-earth metal content (Ca + Mg) | 9 | 5 |
| [mg/kg] - high pressure | | |

As is revealed by the comparison between the results for oil from untreated rapeseed, a not inconsiderable portion of the alkaline-earth metals present in the oil originates from the seed coat. The reduction in the alkaline-earth metal content of oil obtained by high pressure, which is markedly more pronounced in comparison with the normal-pressure experiment, shows that metconazole not only has a systemic effect regarding the alkaline-earth metal content, but also appears to reduce the brittleness of the seed coat.

### 2. Overall Contamination of the Oil

2.1 Overall Contamination of Oil when Treating Oilseed Rape with Boscalid, Boscalid in Combination with Dimoxystrobin, Prothioconazole or Azoxystrobin

Oilseed rape cv. “Lioness” was grown in 2005/2006 in Britain under the normal conditions. During anthesis (growth stage BBCH 61-65), the rapeseed plants were treated by spraying either with boscalid (employed in the form of the commercially available product Cantus®; application rate: 250 g active substance per ha), with boscalid in combination with dimoxystrobin (employed in the form of the commercially available product Pictor®; application rate: in each case 100 g active substance per ha), with prothioconazole (employed in the form of the commercially available product Proline®; application rate: 175 g active substance per ha) or with azoxystrobin (employed in the form of the commercially available product Amistar®; application rate: 200 g active substance per ha). For comparison reasons, some of the rapeseed plants remained untreated. The plants were harvested in summer 2006 (BBCH 92). The rapeseed was pressed with a press from Ökotec under normal pressure (nozzle 8, 40 rpm, temperature at the pressing head 60° C.), and the overall contamination of the oil obtained was determined as specified in DIN EN 12662. The results are shown in the table which follows.

TABLE 4

| | Treatment | | | | |
|---|---|---|---|---|---|
| | | | Boscalid + | | |
| | Untreated | Boscalid | dimoxystrobin | Prothioconazole | Azoxystrobin |
| Overall | 33 | 20 | 10 | 22 | 24 |
| contamination | | | | | |
| [mg/kg] | | | | | |

### 3. Resistance to Oxidation

3.1 Resistance to Oxidation of Oil when Treating Oilseed Rape with Metconazole in Combination with Boscalid and with Tebuconazole in Combination with Prothioconazole

Oilseed rape was grown in 2004/2005 in Germany under the usual conditions. In autumn 2004 (growth stage BBCH 14-16) and in spring 2005 (growth stage BBCH 31-51), some of the oilseed rape plants were treated by spraying with metconazole (employed in the form of the commercially available product Caramba®; application rate: in each case 60 g active ingredient per ha). During anthesis (BBCH 63-65), these oilseed rape plants were then treated by spraying with boscalid (employed in the form of the commercially available product Cantus®; application rate: 250 g active ingredient per ha). Other oilseed rape plants were treated in autumn 2004 (growth stage BBCH 14-16) and in spring 2005 (growth stage BBCH 31-51) by spraying with tebuconazole (employed in the form of the commercially available product Folicur®; application rate: 251 g active ingredient per ha). During anthesis (BBCH 63-65), these oilseed rape plants were then treated by spraying with prothioconazole (employed in the form of the commercially available product Proline®; application rate: 175 g active ingredient per ha). For comparison reasons, the remainder of the rapeseed plants remained untreated. The plants were harvested in summer 2005 (growth stage BBCH 92). The rapeseed was pressed with a press from Ökotec under normal pressure (nozzle 8, 40 rpm, temperature at the pressing head 60° C.), and the resistance to oxidation at 110° C. of the oil obtained was determined as specified in DIN EN 14112. The results are shown in the table which follows.

TABLE 5

| | Treatment | | |
|---|---|---|---|
| | | 2 × metconazole, | 2 × tebuconazole; 1 × |
| | Untreated | 1 × boscalid | prothioconazole |
| Resistance to | 7.2 | 8.4 | 8.6 |
| oxidation at | | | |
| 110° C. [h] | | | |

3.2 Resistance to Oxidation of Oil when Treating Oilseed Rape with Boscalid or with Boscalid in Combination with Dimoxystrobin

Oilseed rape cv. “Talent” was grown in 2005/2006 under the usual conditions at the Tachenhausen site in Germany. During anthesis (growth stage BBCH 61-65), the oilseed rape plants were treated by spraying either with boscalid (employed in the form of the commercially available product Cantus®; application rate: 250 g active substance per ha) or with boscalid in combination with dimoxystrobin (employed in the form of the commercially available product Pictor®; application rate: in each case 100 g active ingredient per ha). For comparison reasons, some of the oilseed rape plants remained untreated. The plants were harvested in summer 2006 (BBCH 92). The rapeseed was pressed with a press from Ökotec under normal pressure (nozzle 8, 40 rpm, temperature at the pressing head 60° C.), and the resistance to oxidation of the oil obtained was determined as specified in DIN EN 14112. The results are shown in the table which follows.

TABLE 6

| | Treatment | | |
|---|---|---|---|
| | | | Boscalid + |
| | Untreated | Boscalid | dimoxystrobin |
| Resistance to | 9.5 | 9.7 | 9.9 |
| oxidation at 110° C. [h] | | | |

### 4. Acid Content

4.1 Acid Content of Oil when Treating Oilseed Rape with Metconazole in Combination with Boscalid and with Tebuconazole in Combination with Prothioconazole

Oilseed rape was grown in 2004/2005 in Germany under the usual conditions. In autumn 2004 (growth stage BBCH 14-16) and in spring 2005 (growth stage BBCH 31-51), some of the oilseed rape plants were treated by spraying with metconazole (employed in the form of the commercially available product Caramba®; application rate: in each case 60 g active ingredient per ha). During anthesis (BBCH 63-65), these oilseed rape plants were then treated by spraying with boscalid (employed in the form of the commercially available product Cantus®; application rate: 250 g active ingredient per ha). Other oilseed rape plants were treated in autumn 2004 (growth stage BBCH 14-16) and in spring 2005 (growth stage BBCH 31-51) by spraying with tebuconazole (employed in the form of the commercially available product Folicur®; application rate: 251 g active ingredient per ha). During anthesis (BBCH 63-65), these oilseed rape plants were then treated by spraying with prothioconazole (employed in the form of the commercially available product Proline®; application rate: 175 g active ingredient per ha). For comparison reasons, the remainder of the rapeseed plants remained untreated. The plants were harvested in summer 2005 (BBCH 92). The rapeseed was pressed with a press from Ökotec under normal pressure (nozzle 8, 40 rpm, temperature at the pressing head 60° C.), and the acid content of the oil obtained was determined as specified in DIN EN 14104. The results are shown in the table which follows.

TABLE 7

| | Treatment | | |
|---|---|---|---|
| | | 2 × metconazole, | 2 × tebuconazole; 1 × |
| | Untreated | 1 x boscalid | prothioconazole |
| Acid number | 0.307 | 0.254 | 0.296 |
| [mg KOH/g] | | | |

4.2 Acid Content of Oil when Treating Oilseed Rape with Boscalid or Boscalid in Combination with Dimoxystrobin

Oilseed rape cv. “Lioness” was grown in 2005/2006 in Britain under the normal conditions. During anthesis (growth stage BBCH 61-65), the rapeseed plants were treated by spraying either with boscalid (employed in the form of the commercially available product Cantus®; application rate: 250 g active substance per ha) or with boscalid in combination with dimoxystrobin (employed in the form of the commercially available product Pictor®; application rate: in each case 100 g active substance per ha). For comparison reasons, some of the rapeseed plants remained untreated. The plants were harvested in summer 2006 (BBCH 92). The rapeseed was pressed with a press from Ökotec under normal pressure (nozzle 8, 40 rpm, temperature at the pressing head 60° C.), and the acid content of the oil obtained was determined as specified in DIN EN 14104. The results are shown in the table which follows.

TABLE 8

| | Treatment | | |
|---|---|---|---|
| | | | Boscalid + |
| | Untreated | Boscalid | dimoxystrobin |
| Acid number | 0.41 | 0.32 | 0.22 |
| [mg KOH/g] | | | |

### 5. Kinematic Viscosity

5.1 Kinematic Viscosity of Oil when Treating Oilseed Rape with Boscalid in Combination with Dimoxystrobin

Oilseed rape cv. “Lioness” was grown in 2005/2006 in Britain under the normal conditions. During anthesis (growth stage BBCH 61-65), the rapeseed plants were treated by spraying with boscalid in combination with dimoxystrobin (employed in the form of the commercially available product Pictor®; application rate: in each case 100 g active substance per ha). For comparison reasons, some of the rapeseed plants remained untreated. The plants were harvested in summer 2006 (BBCH 92). The rapeseed was pressed with a press from Ökotec under normal pressure (nozzle 8, 40 rpm, temperature at the pressing head 60° C.), and the kinematic viscosity of the oil obtained was determined as specified in EN ISO 3104 at 40° C. The results are shown in the table which follows.

TABLE 9

| | Treatment | |
|---|---|---|
| | Untreated | Boscalid + dimoxystrobin |
| Kinematic viscosity [mm²/s] | 35.2 | 33.3 |

### 6. Iodine Number

6.1 Iodine Number of Oil when Treating Oilseed Rape with Boscalid

Oilseed rape cv. “Talent” was grown in 2005/2006 under the usual conditions at the Tachenhausen site in Germany. During anthesis (growth stage BBCH 61-65), the oilseed rape plants were treated by spraying with boscalid (employed in the form of the commercially available product Cantus®; application rate: 250 g active substance per ha). For comparison reasons, some of the oilseed rape plants remained untreated. The plants were harvested in summer 2006 (BBCH 92). The rapeseed was pressed with a press from Ökotec under normal pressure (nozzle 8, 40 rpm, temperature at the pressing head 60° C.), and the iodine number of the oil obtained was determined as specified in EN 14111. The results are shown in the table which follows.

TABLE 10

Treatment

| | Untreated | Boscalid |
|---|---|---|
| Iodine number | 108 | 105 |
| [g iodine per 100 g] | | |

### 7. Sulfur Content

7.1 Sulfur Content of Oil when Treating Oilseed Rape with Boscalid, Boscalid in Combination with Dimoxystrobin, Prothioconazole or Azoxystrobin

Oilseed rape cv. “Lioness” was grown in 2005/2006 in Britain under the normal conditions. During anthesis (growth stage BBCH 61-65), the rapeseed plants were treated by spraying either with boscalid (employed in the form of the commercially available product Cantus®; application rate: 250 g active substance per ha), with boscalid in combination with dimoxystrobin (employed in the form of the commercially available product Pictor®; application rate: in each case 100 g active substance per ha), with prothioconazole (employed in the form of the commercially available product Proline®; application rate: 175 g active substance per ha) or with azoxystrobin (employed in the form of the commercially available product Amistar®; application rate: 200 g active substance per ha). For comparison reasons, some of the rapeseed plants remained untreated. The plants were harvested in summer 2006 (BBCH 92). The rapeseed was pressed with a press from Ökotec under normal pressure (nozzle 8, 40 rpm, temperature at the pressing head 60° C.), and the sulfur content of the oil obtained was determined as specified in EN ISO 20884. The results are shown in the table which follows.

TABLE 11

| | Treatment | | | | |
|---|---|---|---|---|---|
| | | | Boscalid + | | |
| | Untreated | Boscalid | dimoxystrobin | Prothioconazole | Azoxystrobin |
| Sulfur content | 4 | 2 | 2 | 2 | 2 |
| [mg/kg] | | | | | |

1. The use of at least one fungicide which is selected among aryl and heterocyclylanilides, carbamates, dicarboximides, azoles, strobilurins and morpholines for increasing the quality and, if appropriate, the quantity of oil crop products, the increase of the quality being selected among the following criteria:
(i) reduction of the phosphorus content of at least one oil-plant product;
(ii) reduction of the alkali metal and/or alkaline-earth metal content of at least one oil-plant product;
(iii) increase of the stability to oxidation of at least one oil-plant product;
(iv) reduction of the overall contamination of at least one oil-plant product;
(v) reduction of the iodine number of at least one oil-plant product;
(vi) reduction of the acid number of at least one oil-plant product;
(vii) reduction of the kinematic viscosity of at least one oil-plant product;
(viii) reduction of the sulfur content of at least one oil-plant product;
(ix) increase of the flashpoint of at least one oil-plant product;
(x) increase of the net calorific value of at least one oil-plant product;
(xi) reduction of the coke residue of at least one oil-plant product;
(xii) increase of the cetane number of at least one oil-plant product;
(xiii) reduction of the nitrogen content of at least one oil-plant product;
(xiv) reduction of the chlorine content of at least one oil-plant product; and
(xv) reduction of the tin, zinc, silicon and/or boron content of at least one oil-plant product.

2. The use according to claim 1, the oil crop products being selected among the fruits, seeds, presscakes, oil and reaction products of the oil which have been obtained from the oil crops.

3. The use according to claim 2, the reaction products of the oil being the transesterification products of the oil with C₁-C₄-alcohols.

4. The use according to either of claim 2, wherein the oil crop products are selected among the oil obtained from the oil crops and its reaction products.

5. The use according to claim 1, the oil crops being selected among oilseed rape, turnip rape, mustard, oil radish, false flax, garden rocket, crambe, sunflower, safflower, thistle, calendula, soybean, lupine, flax, hemp, oil pumpkin, poppy, corn, oil palm and peanut.

6. The use of fungicides which are selected among aryl and heterocyclyl anilides, carbamates, dicarboximides, strobilurins, azoles and morpholines for reducing the brittleness of the seed coats of seed oil crops.

7. The use according to claim 6, the seed oil crops being selected among oilseed rape, turnip rape, mustard, oil radish, false flax, garden rocket, crambe, sunflower, safflower, thistle, calendula, soybean, lupine, flax, hemp, oil pumpkin and poppy.

8. The use according to claim 1, the fungicides being selected among aryl- and heterocyclylanilides, azoles, strobilurins and mixtures thereof.

9. The use according to claim 1, the aryl- and heterocyclylanilides being selected among compounds of the formula I
A-CO—NHR¹
in which
A is an aryl group or an aromatic or nonaromatic 5- or 6-membered heterocycle which comprises, as ring members, 1 to 3 heteroatoms or heteroatom-comprising groups selected among O, S, N and NR², R² being hydrogen or C₁-C₈-alkyl, the aryl group or the heterocycle optionally having 1, 2 or 3 substituents which are selected independently of one another among halogen, C₁-C₈-alkyl, C₁-C₈-haloalkyl, C₁-C₈-alkoxy, C₁-C₈-haloalkoxy, C₁-C₈-alkylthio, C₁-C₈-alkylsulfinyl and C₁-C₈-alkylsulfonyl;
R¹ is a phenyl group which optionally has 1, 2 or 3 substituents which are selected independently of one another among C₁-C₈-alkyl, C₂-C₈-alkenyl, C₂-C₈-alkynyl, C₁-C₈-alkoxy, C₂-C₈-alkenyloxy, C₂-C₈-alkynyloxy, C₃-C₈-cycloalkyl, C₃-C₈-cycloalkenyl, C₃-C₈-cycloalkyloxy, C₃-C₈-cycloalkenyloxy, phenyl and halogen, it being possible for the aliphatic and cycloaliphatic radicals to be partially or fully halogenated and/or for the cycloaliphatic radicals to be substituted by 1, 2 or 3 C₁-C₈-alkyl radicals and it being possible for phenyl to be substituted by 1 to 5 halogen atoms and/or by 1, 2 or 3 substituents which are independently of one another selected among C₁-C₈-alkyl, C₁-C₈-haloalkyl, C₁-C₈-alkoxy, C₁-C₈-haloalkoxy, C₁-C₈-alkylthio and C₁-C₈-haloalkylthio and the amidic phenyl group R¹ optionally being fused to a saturated 5-membered ring which is optionally substituted by 1, 2 or 3 C₁-C₈-alkyl groups and/or optionally contains, as ring member, a heteroatom selected among O and S.

10. The use according to claim 9, the anilide of the formula I being selected among anilides of the formula I.1 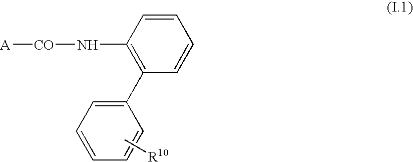
in which A is a group of the formula A1 to A8 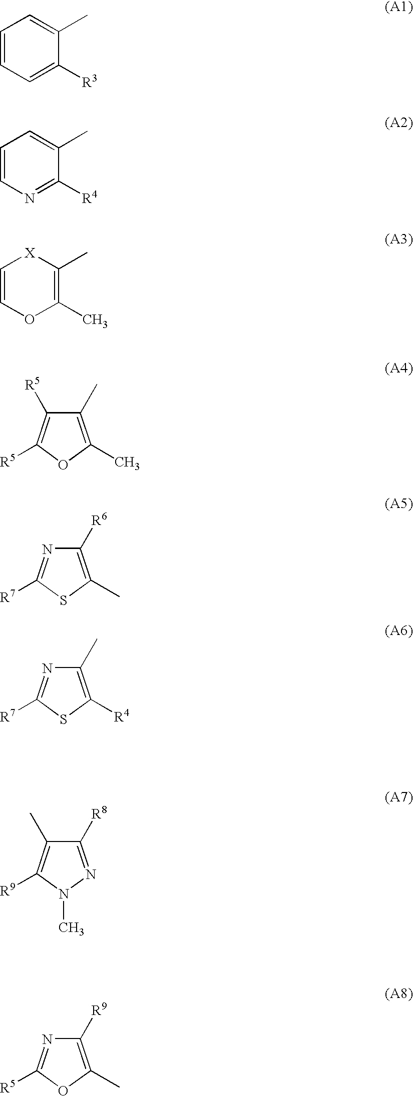
in which
X is CH₂, S, SO or SO₂;
R³ is CH₃, CHF₂, CF₃, Cl, Br or I;
R⁴ is CF₃ or Cl;
R⁵ is hydrogen or CH₃;
R⁶ is CH₃, CHF₂, CF₃ or Cl;
R⁷ is hydrogen, CH₃ or Cl;
R⁸ is CH₃, CHF₂ or CF₃;
R⁹ is hydrogen, CH₃, CHF₂, CF₃ or Cl; and
R¹⁰ is C₁-C₄-alkyl, C₁-C₄-alkoxy, C₁-C₄-alkylthio or halogen.

11. The use according to claim 10, wherein A is the group A2, in which R⁴ is halogen and R¹⁰ is halogen.

12. The use according to claim 11, the anilide I being selected among anilides of the formulae I.1.1 and I.1.2

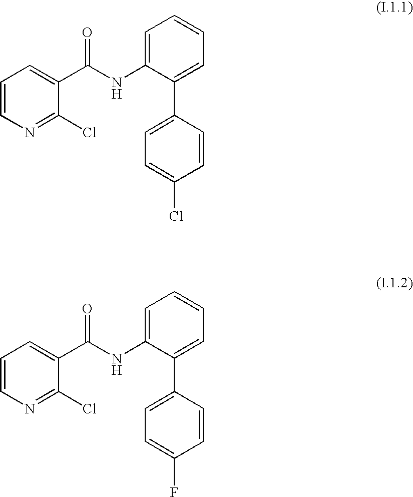

13. The use according to claim 1, the azoles being selected among flusilazol, metconazole, prothioconazole and tebuconazole.

14. The use according to claim 1, the strobilurins being selected among azoxystrobin, dimoxystrobin and pyraclostrobin.

15. The use according to claim 1, the oil crops being selected among oilseed rape and turnip rape.

16. A method of increasing the quality and, if appropriate, the quantity of oil crop products, in which an oil crop or plant parts thereof during the vegetation phase of the plant or its seed are treated with at least one fungicide as defined in claim 1 and in which the oil crop product is obtained, the increase of the quality being selected among the following criteria:
(i) reduction of the phosphorus content of at least one oil-plant product;
(ii) reduction of the alkali metal and/or alkaline-earth metal content of at least one oil-plant product;
(iii) increase of the stability to oxidation of at least one oil-plant product;
(iv) reduction of the overall contamination of at least one oil-plant product;
(v) reduction of the iodine number of at least one oil-plant product;
(vi) reduction of the acid number of at least one oil-plant product;
(vii) reduction of the kinematic viscosity of at least one oil-plant product;
(viii) reduction of the sulfur content of at least one oil-plant product;
(ix) increase of the flashpoint of at least one oil-plant product;
(x) increase of the net calorific value of at least one oil-plant product;
(xi) reduction of the coke residue of at least one oil-plant product;
(xii) increase of the cetane number of at least one oil-plant product;
(xiii) reduction of the nitrogen content of at least one oil-plant product;
(xiv) reduction of the chlorine content of at least one oil-plant product; and
(xv) reduction of the tin, zinc, silicon and/or boron content of at least one oil-plant product.

17. A method for reducing the brittleness of the seed coats of seed oil crops, in which a seed oil crop or plant parts thereof during the vegetation phase of the plant or its seed are treated with at least one fungicide as defined in claim 1.

18. The method according to claim 16, wherein the fungicides are employed in an application rate of 5 to 3000 g of individual active substance per ha per season.

19. A renewable fuel comprising oil obtained from oil crops according to claim 5 and/or at least one transesterification product thereof with C₁-C₄-alcohols.

20. A method of improving the combustion in engines and furnace installations, in which the engines or the furnace installations are operated at least to some extent with an oil crop product according to claim 17.
